(19) United States
(12) Patent Application Publication
(10) Pub. No.: US 2009/0293733 A1
(43) Pub. Date: Dec. 3, 2009

(54) APPARATUS FOR PREPARING BEVERAGES

(75) Inventors: Scott Martin, Kingston Blount (GB); Steve Irwin, Cambridge, MA (US); Andrew Chi Wai Yau, London (GB); David William Smith, Huntingdon (GB); Jake Philip Tuner, Papworth Everand (GB); John McGarva, St. Neots (GB); Patrick Sweeting, Church Lench (GB); Simon James Naylor, Cambridge (GB); David William Harper, Sawston (GB); David Bradshaw, Ely (GB); Michael Robert Nelson, Bar Hill (GB); Martyn Dawes, Kentish Town (GB); Damyn James Musgrave, Cottenham (GB)

Correspondence Address: PATENT DOCKET ADMINISTRATOR;LOWENSTEIN SANDLER PC, 65 LIVINGSTON AVENUE, ROSELAND, NJ, 07068, US

(73) Assignee: COFFEE NATION LTD., Bucks (GB)

(21) Appl. No.: 11/817,212

(22) PCT Filed: Feb. 28, 2006
(86) PCT No.: PCT/GB06/00695

§ 371 Date: May 19, 2009

(30) Foreign Application Priority Data
Feb. 28, 2005 (GB) 0504090.2
Jun. 9, 2005 (GB) 0511754.4
Jan. 30, 2006 (GB) 0601820.4

(51) Int. Cl. A47J 31/60; A47J 31/44

(52) U.S. Cl. 99/280; 99/293; 222/148

(57) ABSTRACT

Various forms of apparatus (1) for preparing and dispensing beverages, preferably based on coffee, can receive instructions from a customer and deliver the beverage automatically. The apparatus is preferably capable of fully automatic cleaning in a cleaning cycle in which a cleaning agent is flushed through the lines (62, 64), and the apparatus is preferably arranged to ensure that not only are the lines cleaned properly but that no cleaning agent can be dispensed. The apparatus includes a brewer assembly (78) having a chamber (81) in which freshly ground coffee can be introduced and either espresso or filter coffee can be automatically prepared by passing hot water through the chamber and removing the spent coffee grounds. The coffee may be stored as coffee beans in sealed containers (208) that can automatically be pierced to release the beans which are ground immediately before preparation of the beverage. The apparatus also includes a cup-size detector (921) for ensuring that the customer offers a cup to the apparatus that is of a size appropriate to the beverage selected.

This invention relates to apparatus for preparing and dispensing beverages on request from a customer. The invention relates especially to apparatus for the preparation and dispensing of coffee beverages, but at least some aspects of the invention are applicable to other beverages.

Coffee beverage vending equipment has been in use for many years. Much of this equipment, however, is able to produce only a limited range of drinks and of poor quality, for example formed by mixing hot water with instant coffee granules or other ingredients. In contrast, this invention is concerned with the provision of apparatus for the preparation of coffee drinks that use fresh ingredients, for example, freshly ground coffee, fresh milk and the like. It is also desired to provide equipment that is capable of producing espresso coffee and optionally also other drinks based on, or associated with, coffee, such as filter coffee, americano, latte, cappuccino, hot milk, hot chocolate and the like.

A further concern is to provide coffee vending equipment that will function with the minimum of manual labour. The equipment will be required to handle ingredients such as fresh milk, and it is therefore important to ensure adequate cleaning of all parts of the equipment that come into contact with such ingredients on a regular basis since even a minute amount of stale milk left in the equipment will constitute a health hazard. However, the operation of cleaning and maintaining the equipment can take a considerable amount of time if performed correctly, and it would be desirable if the amount of labour involved in these processes could be minimised. Ideally, in addition to being able to dispense beverages automatically, it is desirable that the apparatus can clean itself, or at least those parts thereof that are contacted by the beverage or ingredients, especially milk, so that the only manual attention that would be required would be to replenish stocks of ingredients on an occasional basis, and to conduct a simple cleaning operation such as wiping surfaces etc at that time, while the main, regular, cleaning operations are conducted automatically.

According to one aspect, the invention provides apparatus for preparing and dispensing beverages which is adapted to operate in an operating mode in which it can receive instructions from a user to prepare and dispense a beverage, ant to operate in a cleaning mode in which parts thereof are automatically cleaned and in which it cannot dispense a beverage, wherein the apparatus is operative to switch automatically from the operating mode to the cleaning mode in response to a predetermined event.

The predetermined event may be any of a number of events, for example if a sensor detects build-up of undesired material to a given level, or if it is detected that no potential customers are present. Normally, however, the apparatus will be operative to switch from the operating mode to the cleaning mode at a predetermined time, for example a predetermined time of day or a predetermined time after a previous cleaning operation.

According to another aspect, the invention provides apparatus for preparing beverages, which includes a device for storing or preparing a liquid component of the beverage and delivering the component to a beverage dispenser along a line, the apparatus including a storage location for storing one or more cleaning agents for cleaning the line, a device for introducing a predetermined quantity of the or each cleaning agent into the line, and for introducing a quantity of water into the line after introduction of the cleaning agent, in order to rinse the line of cleaning agent, the apparatus including a control mechanism to prevent introduction of the cleaning agent into the line when a beverage is being prepared and dispensed, and to prevent preparation and dispensing of a beverage while the line is being cleaned.

In the broadest consideration, it is necessary to ensure that, on the one hand, the milk line (and any other line) is cleaned thoroughly, and on the other hand, that no cleaning agent is present in a beverage that is dispensed, whenever the cleaning agent was introduced into the line, i.e. whether during a cleaning cycle or otherwise. The equipment is preferably able to ensure this even if any one of the components of the equipment malfunctions. Thus, according to yet a further aspect, the invention may provide apparatus for preparing and dispensing beverages that contain a perishable component, especially beverages that contain milk, which comprises:
(i) a line for the perishable component that is required to be cleaned by means of a cleaning agent;
(ii) a perishable component meter for determining the quantity of perishable component that is dispensed in a beverage;
(iii) means for introducing a quantity of cleaning agent into the line, passing it through the line and removing it from the line during a cleaning operation; and
(iv) a cleaning agent meter for determining the quantity of cleaning agent that is introduced in the line;
   wherein the quantity of cleaning agent that is introduced into the line is also determined by the perishable component meter, and the equipment is operative to prevent dispensing of a beverage and/or generate an alert in the event of a discrepancy between determinations from the perishable component meter and the cleaning agent meter during the cleaning operation.

Thus, the fact that the quantity of cleaning agent that passes through the line during a cleaning operation is determined by both meters can ensure that not only is the correct quantity of cleaning agent used, but can also check that both meters are functioning correctly and that all the cleaning agent has left the line at the end of the cleaning operation. It is also important to ensure that no cleaning agent is introduced during a beverage dispensing operation due to any malfunction of a component for example the cleaning agent pump. This may be prevented for example by including a plurality of components in series along the line, all of which must operate correctly in order to allow introduction of the cleaning agent. For example, a pump may be provided for introduction of cleaning agent into the cleaning agent meter, a second pump may be provided for pumping cleaning agent from the cleaning agent meter to the perishable component line, and a valve may be provided between the second pump and the perishable component line. In such an arrangement, all three components would need to malfunction in order for cleaning agent to be introduced into the line during a beverage dispensing operation.

The apparatus may be arranged so that the cleaning agent passes through the line in a single pass, from the refrigerated cabinet or other point at which it is introduced to the dispenser, or it may include a return path from the dispenser to the line for enabling the cleaning agent to be recirculated in a closed loop before being disposed of or returned to a receptacle for subsequent use. In such a form of apparatus, the beverage dispenser may be movable between a dispensing position in which it enables beverages to be dispensed, and a cleaning position in which it enables the cleaning agent in the in the line to be recirculated, and/or enables external surfaces of the beverage dispenser to be cleaned by the cleaning agent. Thus, the apparatus may include a container, for example of the general form of a spill tray beneath the dispenser that will collect spillages of beverage in normal operation of the apparatus, but during the cleaning operation will hold a quantity of cleaning fluid, into which the dispenser is lowered when it is advanced to its cleaning position. Movement of the dispenser to a position directly above the spill tray during cleaning has the advantage that it is not possible for a customer to place a cup in position during the cleaning operation, and so will prevent the possibility of a customer accidentally receiving cleaning agent instead of the desired beverage.

Whether the cleaning agent is passed through the line in a single pass or recirculated, it is preferable to check the quantity of cleaning agent passing through the line by means of two meters as described above in order to account for all the cleaning agent and to ensure that none is left in the line after the end of the cleaning operation. Thus, if the cleaning agent is continuously recirculated for a time, the cleaning operation should end with the cleaning agent being metered so that all the cleaning agent is accounted for by the end of the cleaning operation.

Thus, the apparatus may be cleaned by a fully automatic cleaning operation controlled by a controller and performed on a regular basis, for example once every few hours to once per day or so, without the necessity for human intervention. The cleaning operation may be controlled so that it is conducted at periods of low usage of the equipment. In addition or alternatively, it is possible for the equipment to include a proximity sensor to detect the presence of a potential customer in the region of the equipment, for example in order to prevent initiation of a cleaning operation when a potential customer is detected.

Since such beverages often contain milk, which needs to be refrigerated, the invention also provides apparatus for preparing and dispensing beverages that include milk, which includes a refrigerated chamber for storing at least one milk container, a milk circuit for allowing milk to be taken from the container and passed to a dispensing arrangement, and means for cleaning the milk circuit along at least a part thereof that is not refrigerated, wherein the milk circuit includes a break in which the part thereof that can be cleaned and a part thereof that cannot be cleaned by the cleaning means are spaced apart from one another to allow cleaning of the milk circuit while allowing milk to remain in the container.

In the apparatus, that part of the milk circuit that is adjacent to the break preferably includes an arrangement that allows introduction of cleaning fluid therein. It is thereby possible to enable cleaning fluid to be introduced automatically and periodically into the milk circuit in an easy manner in order for the milk circuit to be cleaned.

It is possible for the milk container that is located in the refrigerated compartment to be cleaned and re-used if required, depending on the type of apparatus and the circumstances of the operation. However, for a fully automatic operation, it is advantageous for all parts of the milk circuit that cannot be cleaned by the cleaning means to be disposable together with the container. In this way, the parts of the milk circuit that are not automatically cleaned can be simply replaced along with the milk container when the milk supply is replenished.

In addition to the means for handling milk in the beverages and cleaning the equipment, the apparatus is preferably able to prepare high quality drinks such as espresso and filter coffee. This will require a brewer assembly in which freshly ground coffee is introduced, and is compacted while hot water is injected into the coffee at a high pressure, typically from 6 to 12 bar, and ideally at about 9 bar. The water ideally takes about 12-45 seconds to pass through the coffee, and the liquor can be dispensed directly. Depending on the customer's choice, it may be necessary to produce a normal filter coffee as an alternative to espresso. This has a significantly larger quantity of water in the beverage, and often hot water is simply added to an espresso and offered as a filter coffee. Such a beverage is, however an americano rather than a filter coffee. It has been proposed to employ the same brewer assembly for the preparation of both espresso and filter coffee, but one difficulty is that the two drinks require significantly different quantities of water, coffee and brewing pressures.

According to another aspect, the present invention provides a brewer assembly that is capable of brewing both espresso and filter coffee beverages, the assembly having a hollow chamber defined by a chamber body and at least one piston that is movable in the chamber body to vary the volume of the chamber, the piston being movable between a position that allows introduction of ground coffee and ejection of spent coffee, and an espresso brewing position that allows infusion of water into the ground coffee for the preparation of an espresso beverage, the piston being movable to a filter coffee brewing position that causes a higher chamber volume than when in the espresso brewing position, for preparing a filter coffee beverage, the assembly including means for introducing a quantity of water into the chamber during preparation of the filter coffee beverage that causes the beverage in the chamber to be dispensed. The assembly also preferably includes means for moving the piston to reduce the chamber volume when the filter coffee has brewed, in order to dispense the remaining quantity of filter coffee beverage and/or to compress the resulting coffee grounds for example into a puck, for ease of ejection of the spent coffee.

Although it is possible in theory to employ a piston-type brewer for brewing both espresso and filter coffee in which the entire quantity of filter coffee liquor for one cup is contained in the brewer chamber during brewing, if one were to increase the length of the brewer cylinder and the stroke of the pistons, this has the disadvantage that the size of the assembly is considerably increased, and the assembly soon becomes too big to fit into the equipment housing. According to the present invention, an espresso brewer may be employed to brew a filter coffee in which the volume of filter coffee dispensed for each drink is essentially unlimited, or is limited only by the volume of ground coffee that can be introduced into the cylinder.

The assembly may be arranged to introduce discrete quantities of water, for example a first quantity that is introduced with the dry coffee grounds and a second quantity that is introduced after the coffee and first quantity of water have brewed. In this case, the piston may be movable to a position that defines substantially the maximum volume of the chamber, and after the coffee liquor has brewed a second quantity of water may be introduced to displace the coffee liquor and cause it to be dispensed. Finally, the piston may be caused to move in order to reduce the volume of the chamber and so dispense the second (or final) quantity of coffee liquor. Alternatively, a continuous flow of water may be introduced. For example, in one form of assembly, means is provided to meter a quantity of ground coffee into the brew chamber, and the filter coffee brewing position to which the piston is movable is such as to provide a volume in the brew chamber for brewing the coffee that is slightly larger, for example from 5% to 50%, and preferably from 7% to 20% larger than the volume of uncompacted coffee. Water can then be continuously pumped through the brew chamber for example until the required quantity of water for a cup of coffee has been supplied, or nearly all the required quantity has been supplied. For a cup of 340 ml volume, and from 15 to 30 g of ground coffee, a brew time in the region of 30 to 90 seconds, and especially from 40 to 60 seconds will be typical. After finishing pumping the water through the brew chamber, the piston can be moved toward the coffee to expel the remaining water, and the puck of spent coffee can be ejected as described above.

Thus, rather than simply adding hot water to an espresso, the brewing chamber may be used a number of times or continuously to brew a filter coffee, and all the water is used for infusion of the coffee.

The brewer assembly according to this aspect may accordingly be used to prepare a coffee beverage by a process which comprises:
(i) grinding a quantity of coffee and introducing the ground coffee into a brewing chamber defined by a chamber body and at least one piston;
(ii) moving the piston toward the ground coffee until the coffee is enclosed in a chamber volume that is at least 5% larger than the volume of ground coffee;
(iii) pumping hot water into the chamber to allow the coffee to infuse, and pumping coffee liquor so formed out of the chamber;
(iv) after terminating the pumping of the water and coffee liquor, causing the piston to compress the coffee; and
(v) ejecting the compressed coffee from the chamber.

If desired, the piston may be movable to a position that allows escape of air in the chamber that is displaced by the introduction of water for the brewing step, and then be movable to a position in which it seals the chamber before further water is introduced, or the piston may seal the chamber throughout the process and expulsion of air be controlled by other means if necessary, for example by allowing air to be expelled via a line, for example a beverage dispensing line, located above the level of the liquid in the brew chamber. The brewer may contain a single piston only or may be provided with two pistons each of which is movable between different positions at different times during the brewing cycle. Thus, one piston, the upper piston if arranged on a vertical axis, may be movable to a position in which it is entirely located outside the brewing chamber and allows introduction of coffee therein and removal of spent coffee therefrom, and a position within the brewing chamber ready for preparation of an espresso. The lower piston may be movable between a bottommost position in which it allows the chamber to hold the ground coffee that has been introduced therein, and a topmost position in which an upper surface of the piston is generally flush with a top surface of the chamber body so that the lower piston offers up the spent coffee for removal. The assembly may include an element that is arranged to move across the surface of the lower piston in order to remove spent coffee therefrom.

The brewer assembly may include a drive mechanism for the piston that is arranged to move each piston between a topmost position and a bottommost position during a brewing cycle, and may cause the motion of the pistons to exhibit a degree of hysteresis so that the separation between the pistons will vary at different times during the brewing cycle, for example when coffee is being introduced into the chamber, and when the coffee is compacted for infusion of water during brewing of espresso coffee.

The pistons may be connected to a plurality of rods that are capable of moving up or down during the brewing cycle in order to move the pistons between various positions, and both rods may be driven by means of a single motor. The rods may, for example, have a screw thread over a major part of their length, and preferably over substantially their entire length and may be mounted on the chamber body by means of bearings that can engage the rods, so that rotation of the bearings will cause the rods to move axially. The pistons, or piston shafts on which the pistons are mounted, may be attached to the rods by means of mounting bars. If one of the mounting bars is fixed to the rods, the piston associated therewith will follow the motion of the rods, while if the other mounting bar is able to slide axially along the rods to a limited extent, the piston associated with that mounting bar will follow the motion of the rods only during part of the cycle, thereby allowing the separation between the pistons to vary.

Any appropriate arrangement may be employed for the introduction of water to the chamber and removal of coffee liquor therefrom, the arrangement preferably having an inlet and an outlet on opposite sides of the chamber so that water may be caused to flow across the chamber during brewing. The inlet and outlet may be located in the chamber wall or in the piston(s).

Where two pistons are employed, hot water may be introduced into the cylinder via one piston, and coffee liquor may be removed from the cylinder via the other piston so that the water moves axially across the thickness of a generally disc-shaped volume of coffee. If the brewer arrangement is arranged about a vertical axis, water may be introduced through either the upper or lower piston when espresso is prepared. When filter coffee is prepared, it is preferable, although not essential, for the water to be introduced through the lower piston. The reason for this is that air in the brew chamber before filling with hot water may be expelled through the upper piston. Also, a fine filter will normally be provided at the outlet for the coffee liquor, while a relatively coarse filter will normally be provided at the water inlet. If coffee liquor leaves the chamber through the lower piston, a fine filter thereon can become clogged up with fine coffee solids. If, on the other hand, the coffee liquor leaves the brew chamber through the upper piston, the coffee solids will tend to drop back into the chamber instead of clogging the filter. Introduction of water through the bottom piston has the further advantage that the upward flow of water through the cylinder when preparing filter coffee will prevent the coffee grounds settling and keep them in suspension.

The milk may be supplied in a disposable milk supply unit, for example one having a pipe extending therefrom through which milk can be dispensed, and a device, for example a peristaltic pump, may be provided that cooperates with the milk supply unit to allow and prevent flow of milk. Preferably, the milk is supplied in so-called “bag-in-boxes” in which a sealed flexible plastics bag is contained within a relatively rigid box, formed for example from cardboard, and the bag may be provided with a length of flexible tube extending therefrom. The tube may be sealed before use, and the end thereof may be cut when the bag-in-boxes are installed in the apparatus. The disposable part of the milk line that is attached to the milk container may be flexible, and the apparatus may include means for gripping the line to retain milk in the container and for releasing its grip on the line to allow milk to be delivered from the refrigerated compartment, for example a pinch valve. The means for gripping the lines or pinch valves are preferably electrically operable in order to enable remote actuation thereof by a control mechanism in the equipment. Such a form of pinch valve may be used to allow milk from one container to be dispensed to a beverage while preventing milk from another container from being dispensed, for example because one of the containers has run out, because it has passed its use-by date, or in order to rotate the stock of milk in the refrigerated compartment. The electrically actuatable pinch valves are novel per se, and so, according to yet another aspect, the invention provides apparatus for preparing beverages that include milk, which comprises a refrigerated compartment for containing one or more milk containers, the or each of which is provided with a flexible line for allowing supply of milk from the compartment, the apparatus including a device, associated with each flexible line for gripping the line to retain milk in the compartment and for releasing its grip on the line to allow milk to be delivered from the compartment, the or each device being electrically operable to enable remote actuation thereof.

Such containers can be relatively large, for example having a volume in the order of 5-25 litres, typical standard sizes being 13.6 litres. Also, if it is desired to reduce the frequency with which the milk containers need to be replaced, for apparatus that is employed in a busy location, a number of containers will need to be replaced at a time, in which case the total weight of milk will be significant. Thus, according to another aspect, the invention provides apparatus for preparing beverages that include milk, which comprises a refrigerated compartment having a removable panel, the panel having an arrangement for holding one or more milk containers, and having an arrangement for engaging a device that enables the panel and milk containers to be removed from the compartment and wheeled to a remote location, and enables the panel and milk containers to be wheeled from a remote location to the compartment and attached thereto so that the or each container is located within the compartment. Accordingly, when the milk is to be replenished, the panel may be attached to the device, for example in the form of a trolley, wheeled to a location where the old containers are removed and replaced with new containers, wheeled back to the apparatus and reinstalled in the refrigerated compartment. If the refrigerated compartment is in a lower part of the equipment, it is possible, and desirable, for the removal and reattachment of the panel to be achieved without altering the height of the container(s), thereby obviating the need to lift them.

The apparatus may include means for determining whether the or any container is empty, and a controller that causes the gripping device or pinch valve to be actuated so as to grip its associated line permanently (that is to say, until the associated container is replaced) if the container is empty, so as to prevent the possibility of any old milk being dispensed.

The apparatus may, for example, include a dosing device that is associated with the milk line and will dose a predetermined quantity of milk when a beverage is being dispensed. Thus, according to another aspect, the invention provides apparatus for preparing beverages that include milk, which includes a milk line that extends from a storage location for the milk to a dispensing location in which the milk is dispensed, and a dosing device that is associated with the milk line and is operative to sense the weight or volume of milk received from the storage location and to allow a quantity of milk to be dispensed in accordance with the quantity of milk received from the storage location. The device may be arranged to measure the volume of milk received for example by optical or electrical means, or, as described below, the weight of the milk.

This dosing device may be employed to determine whether any milk container is empty, and thus require that one of the dispensing lines is closed and another container is used for the supply of milk. The dosing device preferably comprises a receptacle for milk from the line, means for determining the volume of milk or the weight of the receptacle and milk contained therein, and a valve for closing the line upstream of the receptacle if the quantity of milk, normally the weight of the receptacle and milk, exceeds a predetermined value. In such a case, the receptacle may be spaced apart from the milk line upstream and/or downstream thereof, and may be capable of moving vertically to a limited extent in order to allow determination of the weight of milk therein, for example by means of a spring or any other means for determining a load, such as an arm that can detect the strain therein. By spacing the milk receptacle apart from the milk line, cleaning of the receptacle can be considerably simplified, and by separating the receptacle from the measuring device, only the receptacle, which is easier to clean than the measuring device, is ever in contact with the milk.

Where the compartment holds a number of containers, the dosing device or other means for determining whether a container is empty together with the pinch valves can enable swift and simple changeover of the milk containers as soon as one is empty or when the milk in the container has passed its use-by date, and the changeover may be performed even during the dispensing operation for a beverage. Thus, the apparatus preferably includes a valve associated with each container for opening and closing a line of that container which is arranged to open the line to allow a quantity of milk to be dispensed for a beverage, and to close the line to terminate dispensing of the milk, and the sensor is arranged to monitor the quantity of milk dispensed in each beverage, the sensor being operative to cause the valve to close the line permanently (i.e. until replacement of the container) if it detects that no milk has been supplied from that line during a dispensing operation. By monitoring the quantity of milk dispensed in each beverage rather than the total quantity dispensed or remaining in the container, and switching the containers where necessary, it is possible to ensure that the customer is never given an insufficient quantity of milk while at the same time reducing the quantity of unused milk remaining in the containers. In addition, the quantity of milk remaining can be tracked by the equipment for the retail staff.

According to yet another aspect, the invention provides apparatus for preparing and dispensing beverages, which includes a device for enabling a customer to select a beverage, a dispensing head for dispensing a beverage into a cup placed under the dispensing head, and an arrangement for moving the dispensing head and/or a support for the cup vertically in accordance with the beverage selection so that the position of the dispensing head with respect to the support for the cup is appropriate to the size of cup for the selected beverage. The ability of the dispenser or dispensing head to move vertically has the advantage that it is possible for it to adjust its position to the size of cup placed in the dispensing location.

Such apparatus has the advantage that it is possible to set the largest size of cup that can be used during the selection of a beverage, thereby preventing customers selecting a number of low volume beverages such as espressos and dispensing them into a large cup, and thereby, either by accident or design and depending on the payment method chosen, evading payment. The apparatus has the further advantage that, because the dispensing head can be positioned relatively close to the surface of the beverage in the cup, the gap between the dispensing head and the surface is reduced, and soiling of the equipment by splashing of the beverages can be considerably reduced.

This form of dispensing head may advantageously be combined with one or more sensors for detecting the presence and optionally the size of a cup that has been placed under the dispensing head, and a controller that will prevent dispensing of a beverage if an incorrect size of cup has been placed under the dispensing head. Thus, it is possible to guard against too small a cup being selected for the beverage chosen, which would result in overflow of the beverage and soiling of the apparatus. According to this aspect, the invention provides apparatus for preparing and dispensing a beverage selected from a range of beverages of different volumes into a cup offered by a customer, which comprises a detector for detecting the size of the cup offered by the customer; a memory containing a plurality of messages to be displayed; a controller for selecting operation of the equipment and/or a message or warning in dependence on the detector and the beverage selected by the customer; and a display for displaying a message in the memory.

In some instances, the controller may operate to cause the equipment to display the message in addition to causing the equipment to dispense the beverage, while in other instances, for example where the equipment displays a warning or an incorrect choice has been made, the controller may be operative to suppress operation of the equipment until the cause of the warning has been removed.

The message display and the input device for receiving instructions from a user may advantageously be combined in a single device, for example in the form of a touch screen. Thus, according to yet a further aspect, the invention provides apparatus for preparing and dispensing beverages which comprises one or more sensors for sensing a physical condition of the apparatus, a touch screen for displaying messages and for receiving instructions from a user, a memory for storing data relating to the beverages and/or the operation of the apparatus, and a controller for controlling operation of the touch screen or apparatus, so that the apparatus will dispense a beverage only when an instruction received by the apparatus is compatible with the physical condition of the apparatus as sensed by the sensor(s). According to this aspect, the controller may cause information relating to the physical condition to be displayed by the touch screen in the event of incompatibility between the instruction and the physical condition.

The physical condition may relate to the presence or absence of ingredients and of corresponding changes to the range of beverages offered by the equipment, or to the type of beverage that has been selected by the customer. Alternatively, the physical condition may relate to the size of a cup that is offered by the customer so that the apparatus will indicate the wrong size cup and prevent a beverage being dispensed. Also, it is possible for the physical condition to be the fact that the apparatus has entered a cleaning cycle and so is unable to dispense a beverage.

In order to prepare beverages that contain foamed milk, the milk needs to be mixed with steam in order to heat it, and also with air in order to give the foamed milk an appropriate body. This has conventionally been achieved in a number of ways, for example by introducing steam into a container of milk by means of a wand, and allowing air to become entrained in the milk, or by passing steam through a venturi, and allowing the milk to be drawn into the venturi throat. Such methods, however, have the disadvantage that there is no control over the foamed milk that is produced.

According to another aspect, the invention provides apparatus for preparing foamed milk beverages, which includes an arrangement for foaming milk by introducing milk, air and steam into a mixing chamber, the apparatus having means for independently varying the relative flow rate of the milk, air and steam. According to this aspect, the air, milk and steam are all supplied under a positive pressure, for example by means of a pump in the case of the milk and air, and the flow rate of each fluid may be adjusted, or the flow rate of two of the fluids may be adjusted with respect to the third fluid, to ensure the desired product. For example, the adjustment may be made when commissioning the apparatus, or it may be made electronically whenever a different beverage is required.

This aspect of the invention has the advantage that it can be used reliably to form foamed milk products of desired consistency because the quantity of any of the ingredients is not dependent on the quantity of any of the other ingredients that are supplied. For example, the flow rate of steam may be set as a constant and be determined by the power input to the steam boiler and the design of the equipment, while the flow rate of the air and milk may be controlled by pumps and varied by a control device in accordance with the product selected.

It is also desirable to provide a fully automatic process of storage and dispensing of coffee beans to the bean grinder in such a manner that oxidation of the coffee between opening of sealed coffee bean containers and use of the coffee is reduced, while, at the same time, operating the system with relatively long periods between operations requiring human intervention such as replenishment of the stock of coffee. Thus, according to yet another aspect, the present invention provides apparatus for preparing and dispensing coffee beverages, which comprises a coffee brewer, a coffee bean grinder, and a coffee bean store that is located above the coffee bean grinder, and is arranged to receive a plurality of containers of coffee beans at a plurality of locations therein, the coffee bean store including a piercing arrangement located below at least one of the locations therein, and the piercing arrangement being arranged to move vertically upwards to pierce one of the containers to cause coffee beans to pour from the container into the bean grinder.

The apparatus will advantageously include a sensor to detect the quantity of coffee beans in the bean grinder, and a controller to actuate the piercing arrangement when the quantity of coffee in the grinder falls below a predetermined quantity, so that the piercing arrangement can proceed to open a further container.

It is possible for the coffee bean containers to be static and for the piercing arrangement to move to each different coffee bean container, or alternatively, for the containers to move to the location of the piercing arrangement. In the latter case, it is convenient for the containers to be located on a movable holder that is arranged to advance the containers when one of the containers has been pierced or is due to be pierced, so that a full container is located above the piercing arrangement. Thus, a number of containers may be arranged on a carousel that is arranged to be rotated stepwise in order to align a container with the piercing arrangement. The piercing arrangement may, for example, include a generally cylindrical cutter whose upper end forms one or more sharp cutting edges that can pierce and cut a metal foil seal of the bean container. Once pierced, the beans can then pour through the cutter into a hopper for a bean grinder located directly below. Such an arrangement may hold from two to ten containers, typically four, so that the coffee bean containers need only be replenished occasionally, for example once per week, but the coffee beans will be exposed to air for a much shorter length of time in order to reduce oxidation.

Thus, according to yet another aspect of the invention, there is provided apparatus for automatically preparing and dispensing coffee beverages, which comprises a coffee bean store for containing a plurality of sealed containers of coffee beans, means for automatically opening the containers, a coffee bean grinder for receiving beans from a container and grinding them, a coffee brewer for brewing ground coffee, and a refrigerated compartment for storing one or more containers of milk to be dispensed in the coffee beverages, wherein the coffee bean store is capable of holding a plurality of containers of coffee beans so that the coffee may remain in the coffee bean store sealed from the atmosphere before requiring replenishment for periods of time corresponding to the usable lifetime of the milk in the refrigerated compartment, but will be exposed to the atmosphere only for a fraction of such periods of time.

The ratio of usage of coffee to that of milk will depend on a number of factors, in particular the pattern of consumption of various types of beverage, for example the consumption of milk-containing beverages such as white coffee, latte and the like to non-milk-containing coffee such as espresso, but it has been determined that approximately 8 to 20 litres of milk, and especially from 10 to 15 litres of milk are consumed for each kilogram of coffee beans consumed, so that equipment containing 50 to 60 litres of milk would be appropriate for four 1 kg containers of coffee beans. In addition, the quantity of coffee beans stored in each container will usually depend on the rate of consumption of coffee and the containers are chosen so that coffee beans are not left exposed to the atmosphere for too long after opening the containers, that is to say, so that the rate of consumption of coffee is greater than the rate of decay of the coffee. The container of coffee is preferably left for no longer than seven days, more preferably no longer than four days, and especially no longer than three days, after opening before its contents are used.

The containers of coffee are novel per se, and so, according to another aspect, the invention provides a container that contains from 0.7 to 1.5 kg of roasted, unground, coffee beans, more preferably from 0.8 to 1.2 kg of coffee beans, and especially approximately 1 kg of coffee beans, the container having an air-impermeable lining and containing an inert gas to prevent oxidation of the coffee beans. The containers will typically have a volume in the range of from 2.5 to 4 litres, and preferably from 3.0 to 3.5 litres (which will deliver a quantity of approximately 3 litres with an ullage or quantity of contents lost of about 10%) and may have a lining of a metal foil, for example aluminium foil, which will prevent air ingress and will be pierceable to allow opening of the container. The container will normally contain an inert gas in addition to the coffee beans in order to prevent oxidation of the coffee. Thus, the container may be filled nitrogen or carbon dioxide from a supply, or it may contain carbon dioxide formed from the beans after they have been introduced into the container.

The preferred container is generally cylindrical, having one end that is closed by a metal, e.g. steel, end cap, and another end that has a peripheral annular rim that is closed by the foil. Although generally cylindrical, the container is preferably not symmetrical about its axis, and has a configuration that will prevent it being positioned in the equipment with the wrong orientation.

The apparatus according to the invention thus enables making a multiplicity of coffee beverages with significantly reduced manual labour, by a process which comprises:
i) supplying a quantity of coffee beans;
ii) selecting milk to be included in the beverages based on the use-by date of the milk;
iii) adjusting the relative quantities of coffee, milk and air to form a coffee beverage; and
iv) controlling the operation of the process as a function of the size of a cup selected by a customer.

Thus, according to yet another aspect, the invention provides apparatus for automatically making a multiplicity of coffee beverages, which comprises:
i) a bean store for containing a quantity of beans sufficient for a number of cups of coffee;
ii) a refrigerated milk store for containing a quantity of milk sufficient for a number of cups of coffee that contain milk;
iii) means for receiving a request from a customer for a single coffee beverage;
iv) means for detecting the size of a cup selected by the customer;
v) means for grinding a quantity of the beans sufficient for the single coffee beverage;
vi) means for brewing the coffee beverage using the ground quantity of beans;
vii) means for selecting a quantity of milk for the coffee beverage from the milk store so that the milk selected for the beverage is within a use-by date of the milk in the milk store;
viii) means for adjusting the quantities of the brewed coffee and milk in accordance with a recipe for the coffee beverage that is held in the apparatus;
ix) means for dispensing the coffee beverage; and
x) a controller for controlling dispensing of the coffee beverage based on the size of the cup selected by the customer so that the quantity of the coffee beverage dispensed is appropriate to the size of the cup.

Equipment thus enables coffee beverages to be made and dispensed by a process using a coffee making machine actuable to make and dispense cups of coffee in response commands input by users, comprising:
(a) providing in said machine a plurality of sealed containers each containing a quantity of coffee beans sufficient for making a plurality of cups of coffee, the coffee beans in each container having a freshness life of not more than two days after opening of the respective container;
(b) causing said machine to open said containers in sequence so that only one said container is opened at a time;
(c) causing said machine, in response to the input of a plurality of said commands over a period not greater than said freshness life, to make and dispense a plurality of cups of coffee utilising coffee beans from said open coffee container such that substantially all of the coffee beans in said open container are used up within said freshness life;
(d) causing said machine automatically thereafter to open a further said coffee container and, in response to the input of a further plurality of said commands over a further period not greater than said freshness life, to make and dispense a further plurality of cups of coffee utilising coffee beans from said further coffee container such that substantially all of the coffee beans in said further coffee container are used up within said freshness life; and
(e) manually replacing the coffee containers from which the coffee beans have been used up by new said sealed containers a plurality at a time.

Preferably, the machine contains at least four containers, and the manual replacing step is carried out not more than once every two days. Alternatively or in addition, the machine may transmit a coffee replenishment signal in response to a predetermined number of the said coffee containers having been opened or the coffee used up, to indicate the need for manual replacing of the coffee containers. In addition, the process may include providing in said machine a plurality of containers of milk each having a use by date and causing said machine to select milk, when making cups of coffee requiring milk, only from a said milk container within its use by date. The machine may be caused to transmit a milk replenishment signal in response to a predetermined number of said milk containers having been used up or selected and/or having reached the use-by date of the milk contained therein. Also, the machine may be caused to execute a cleaning cycle at least once each day for cleaning milk residue from said machine.

One form of beverage apparatus in accordance with the present invention will now be described by way of example with reference to the accompanying drawings in which:

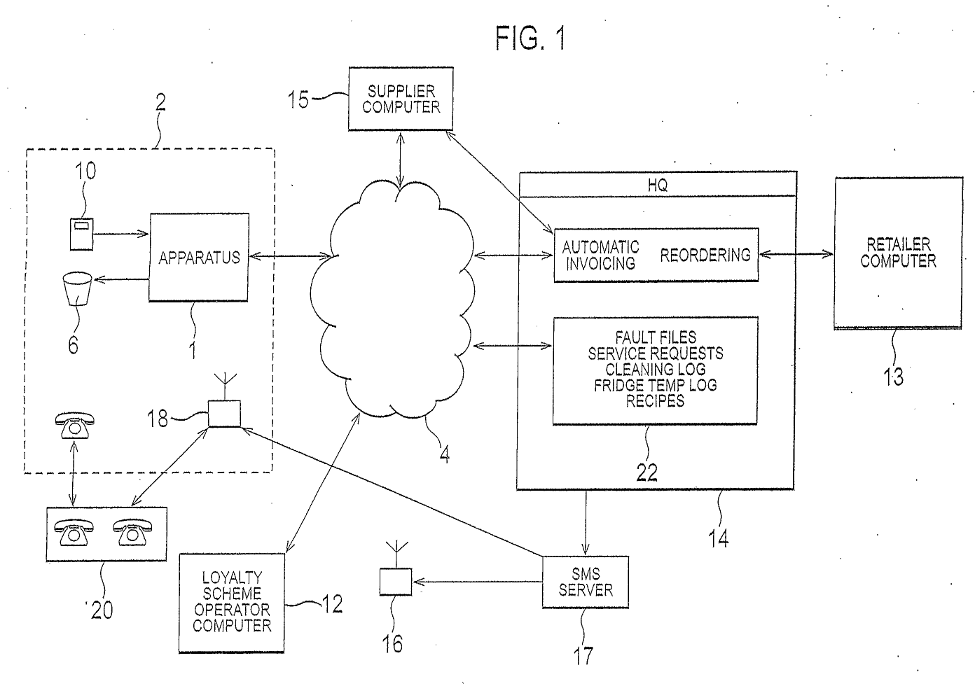

FIG. 1 is a schematic diagram showing the environment in which the apparatus may be employed;

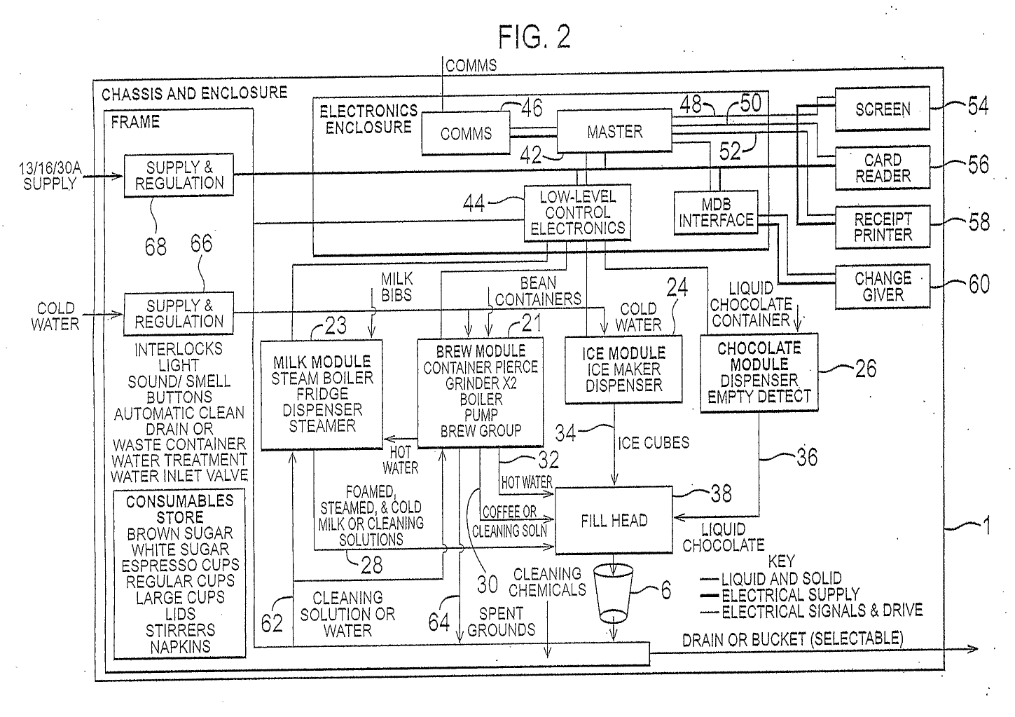

FIG. 2 is a schematic plan of the apparatus showing the main elements thereof;

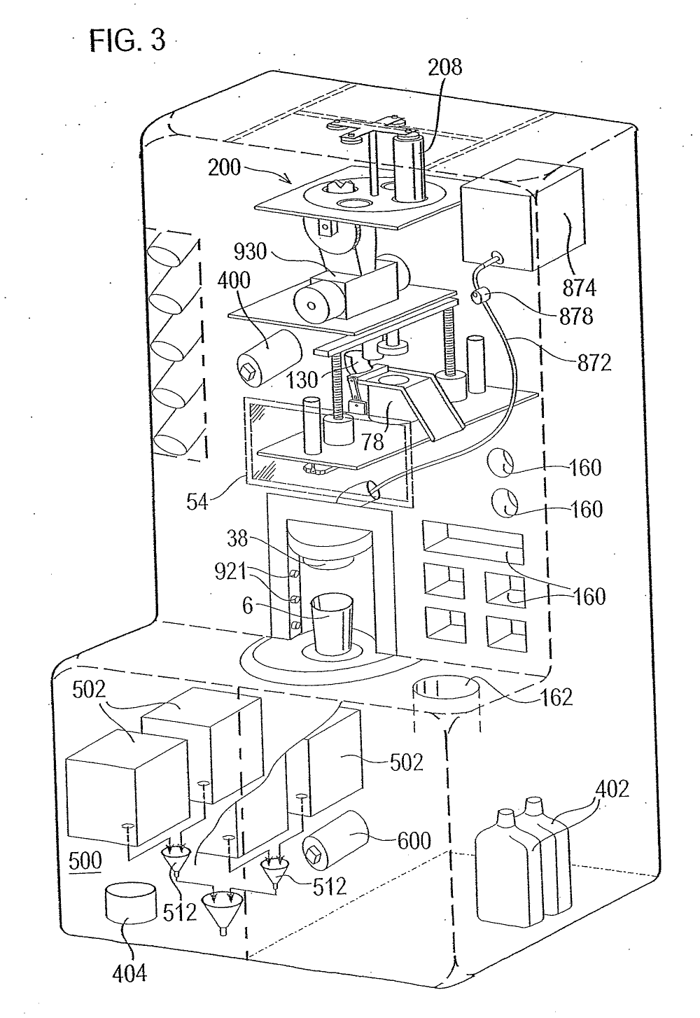

FIG. 3 is a schematic perspective view showing the coffee apparatus;

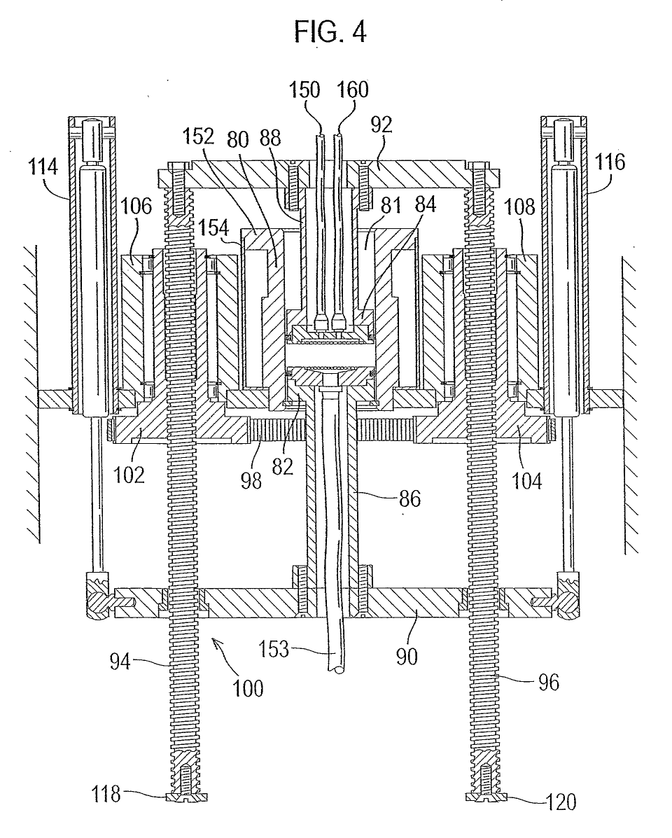

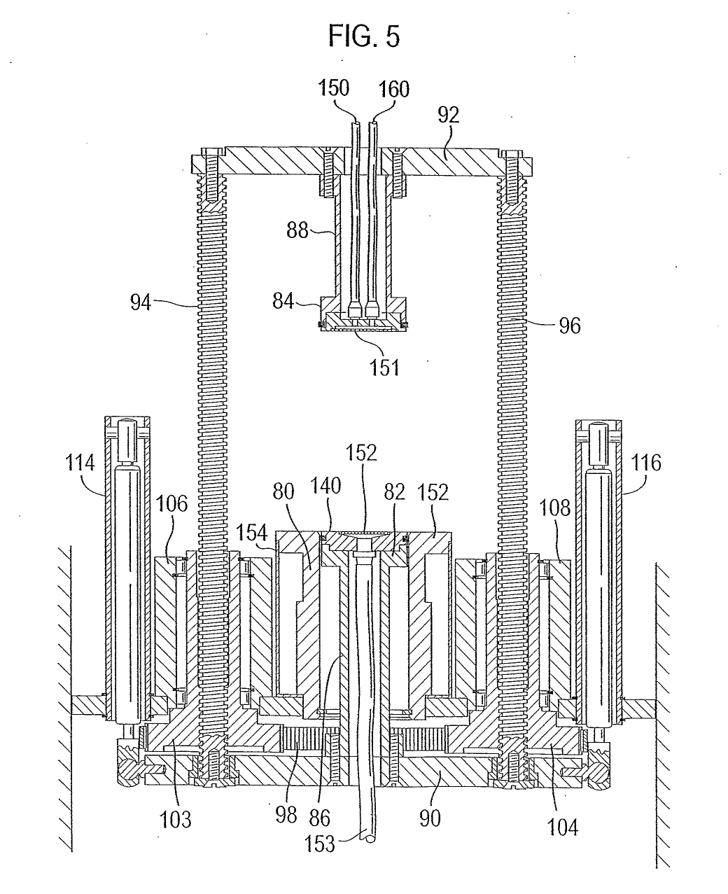

FIGS. 4 and 5 are schematic sections through the brewer arrangement in two different positions;

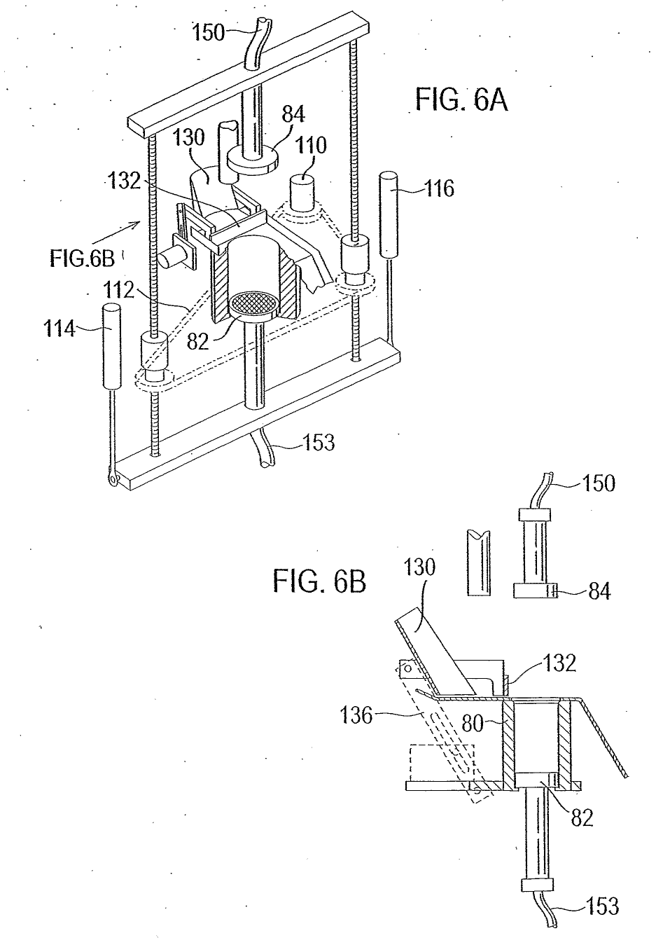

FIGS. 6 to 9 are perspective views showing the main elements of the brewer arrangement during a brewing cycle;

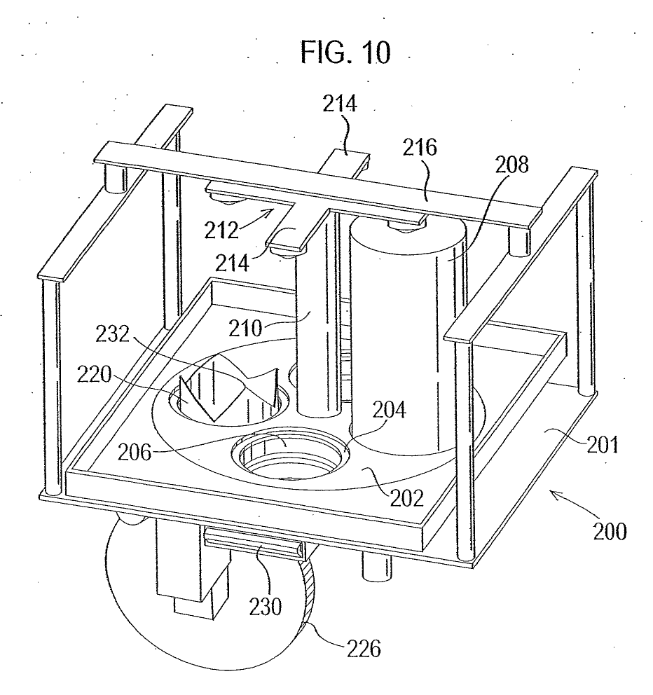

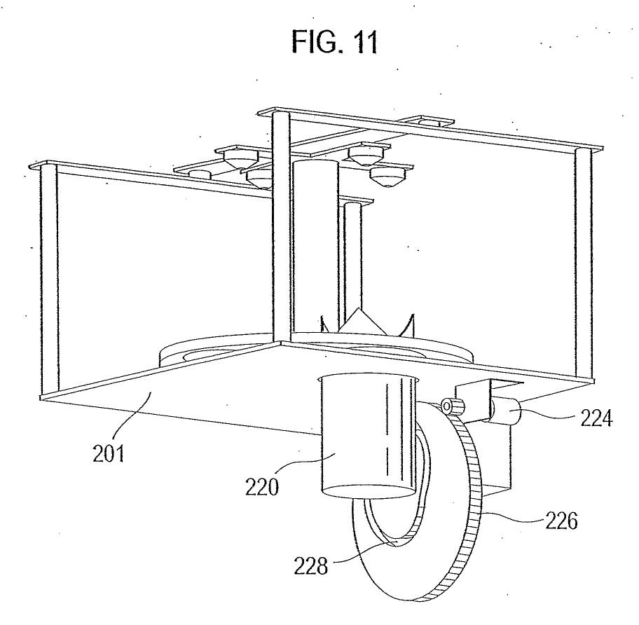

FIGS. 10 and 11 are perspective views of the coffee bean container storage and piercing arrangement;

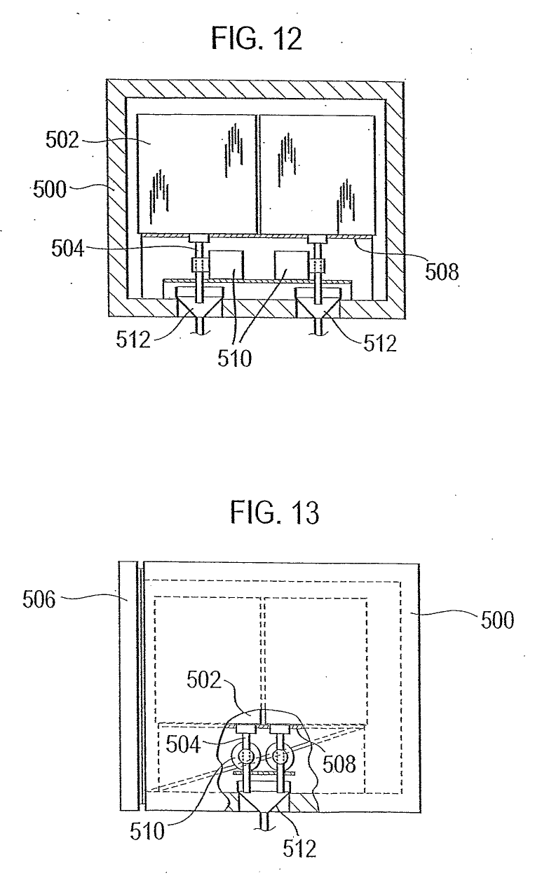

FIGS. 12 and 13 are side views of the refrigerated compartment employed in the equipment;

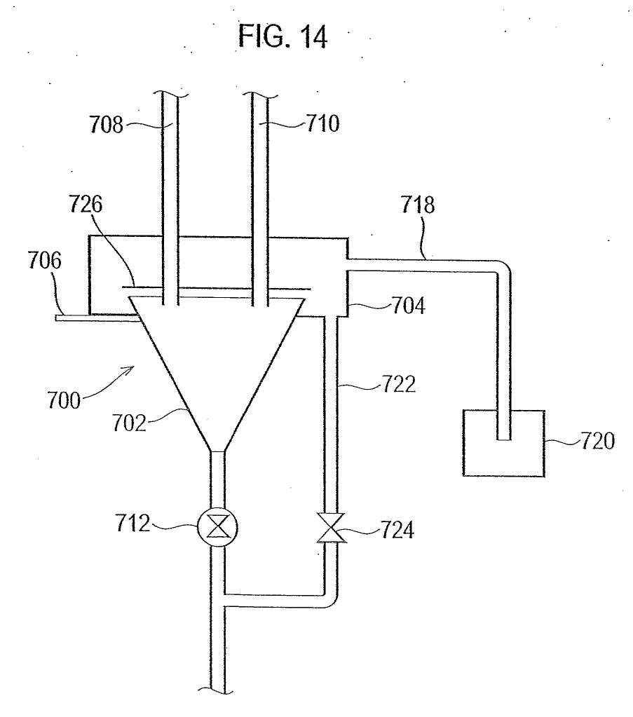

FIG. 14 is a schematic side view of the load cell for metering milk;

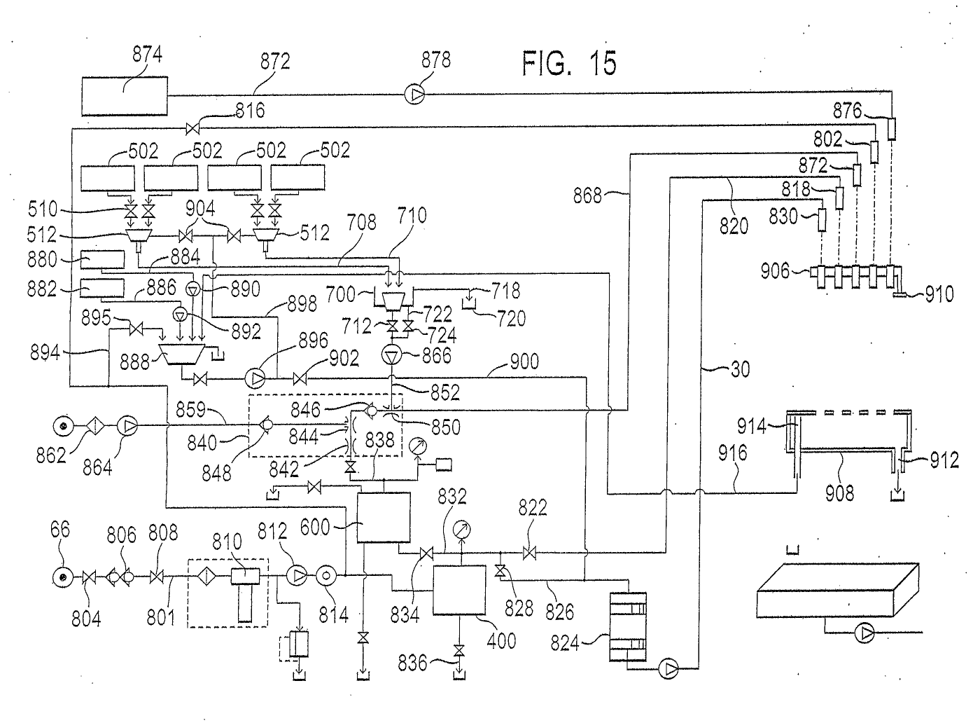

FIG. 15 is a schematic layout of the fluid system of the equipment;

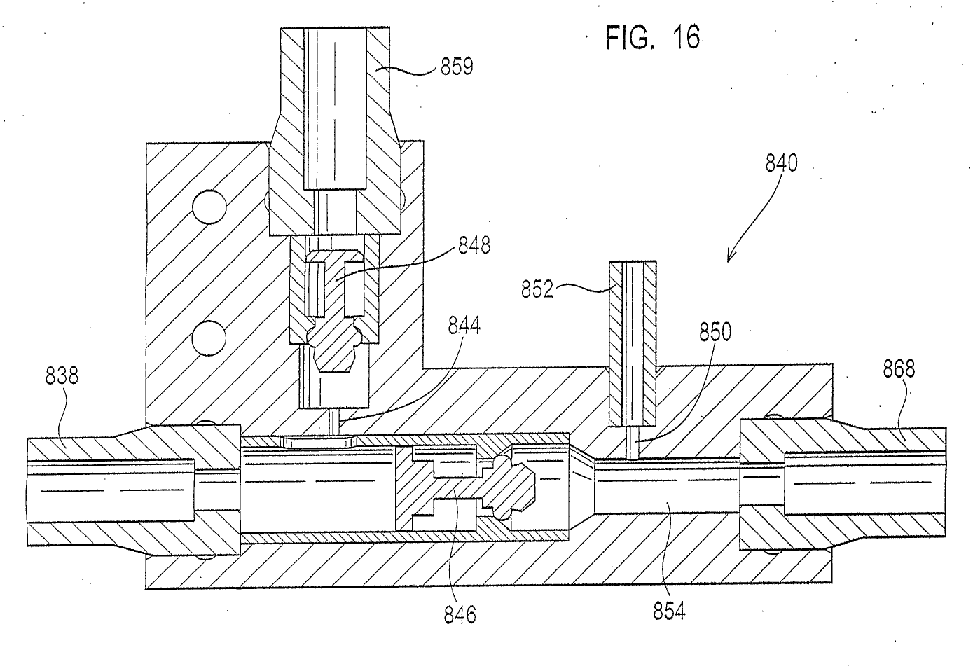

FIG. 16 is a section through the steam, air and milk mixing unit;

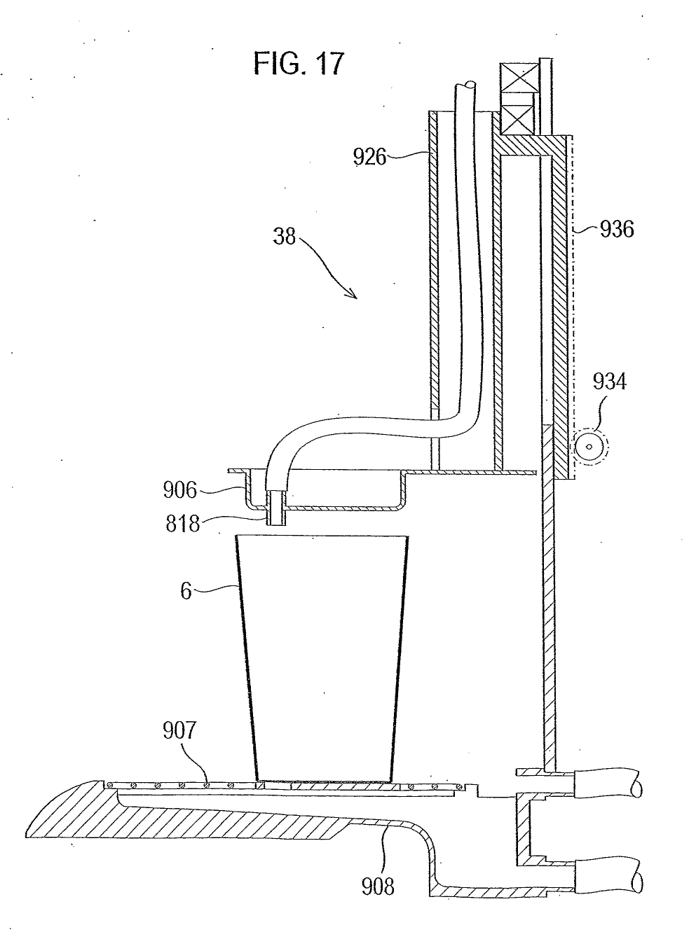

FIG. 17 is a schematic section through the fill head and drip tray during dispensing of a beverage;

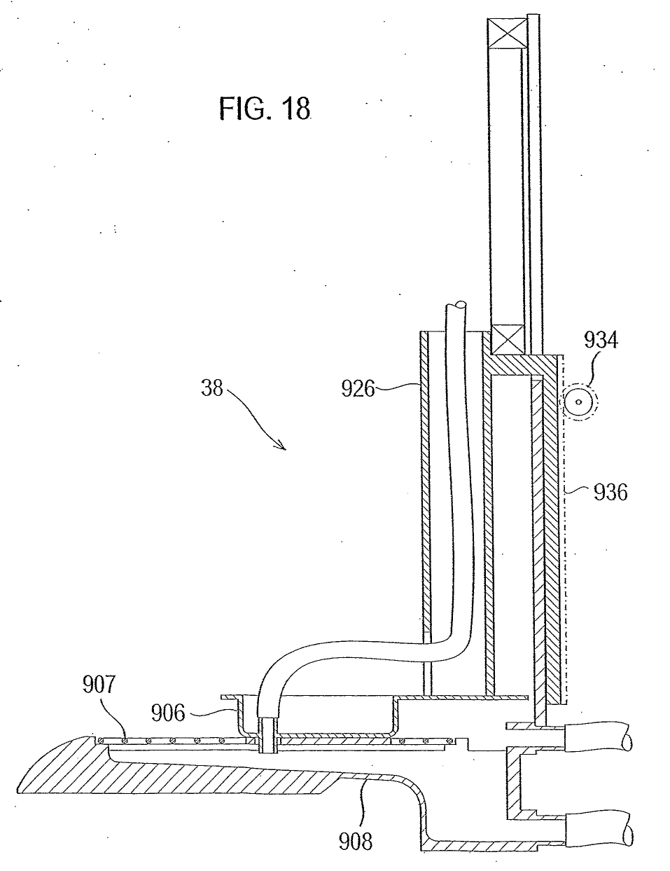

FIG. 18 is a schematic section through the fill head and drip tray during the cleaning operation;

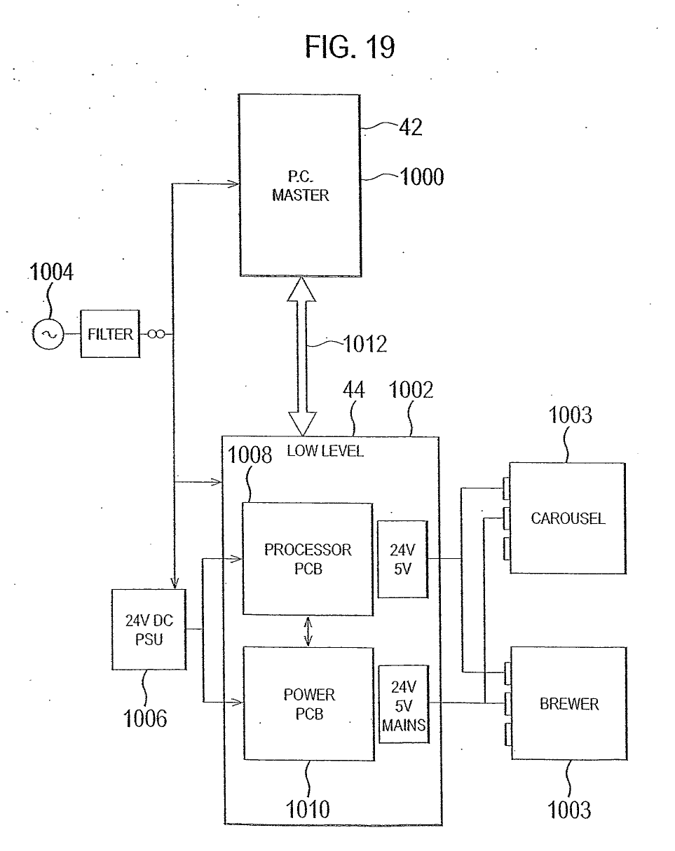

FIG. 19 is a schematic diagram of the main electronics components;

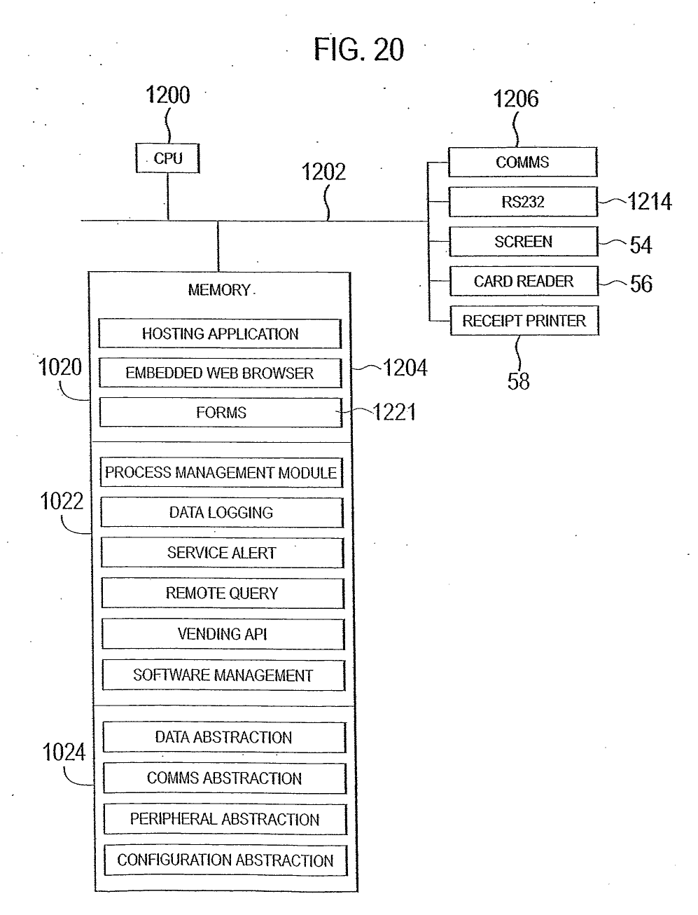

FIG. 20 is a schematic view showing the main elements and data storage of the master controller of FIG. 19;

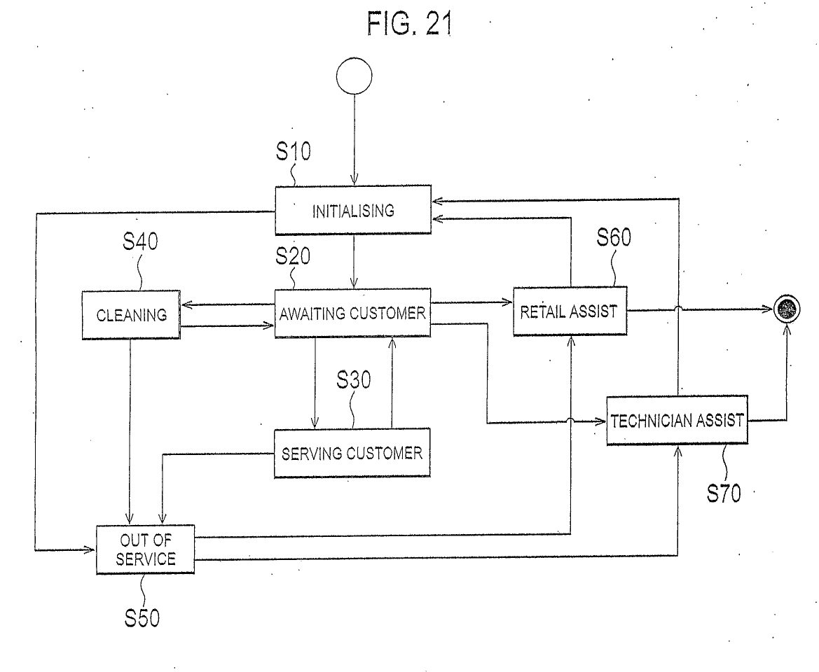

FIG. 21 is a state transition diagram of the operation of the main controller;

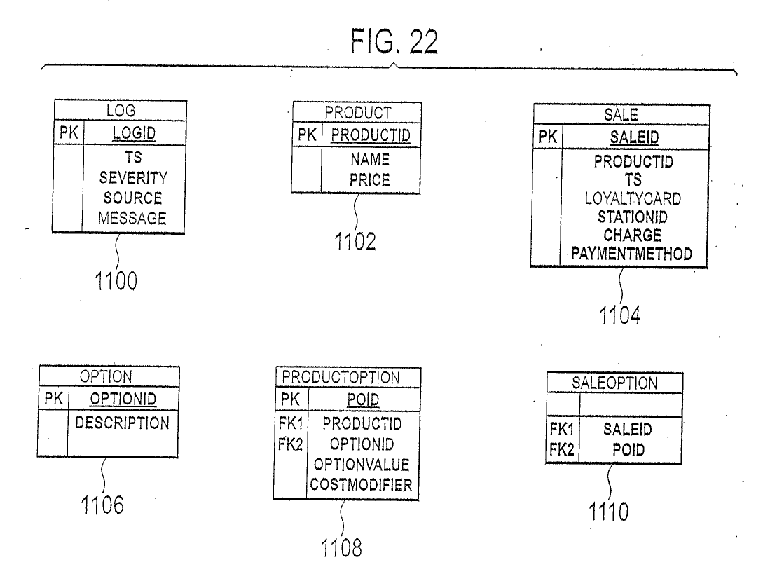

FIG. 22 is a schematic diagram of the main elements of the operating logic database; and

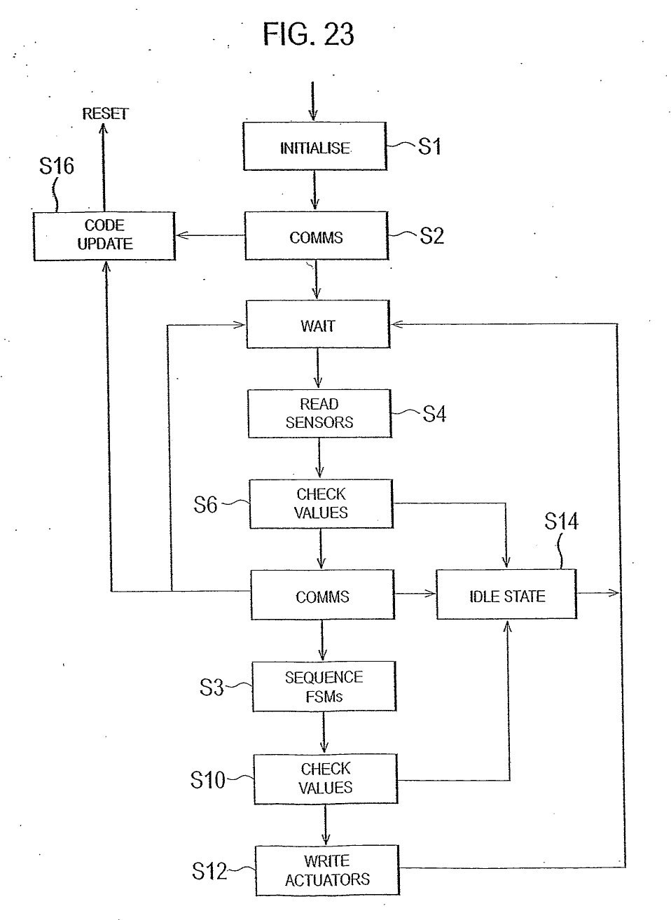

FIG. 23 is a flowchart showing the main steps of the low level software.

Referring to the accompanying drawings, FIG. 1 shows the environment in which the apparatus may be employed. The apparatus 1 will normally be located in a retail outlet 2 that is controlled by a third party retailer. The apparatus is intended to dispense a beverage 6 to a customer who will pay for the beverage at the retail outlet 2 using the retail outlet's cash collection facility. If desired, alternative methods of payment may be employed. For example, the apparatus may be arranged to enable the customer to pay for the beverage at the machine, for example using cash or a card, either in addition to, or instead of, other payment methods.

Depending on the particular operating scheme, the customer may be given a loyalty card 10 that is used with the apparatus 1, and which may, for example, determine the price of the beverage, allow the apparatus to dispense a beverage free of charge or provide some other benefit to the customer in return for purchases. The loyalty card may be administered as part of a loyalty scheme that may be run by the owner of the apparatus, the retailer, or by some other organization. Typically, the loyalty scheme will be administered by a computer 12 that communicates with the apparatus via a network 4 such as the internet.

The apparatus 1 may be provided with means for communicating with a computer 14 located in the owner's establishment for the purpose of sending and receiving information. Such information may, for example, include details of sales of each beverage for the purpose of determining what revenues are due to whom in respect of beverage sales, and details of sales of beverages for the purpose of re-ordering ingredients and other consumables, for example by automatically notifying a supplier's order management computer system either directly or via the network 4. The information may also be communicated to a computer 13 located in the retailer's premises for the purpose of invoicing and receiving payment from the appropriate party. Messages or instructions may be sent to a short message service (SMS) server 17 for forwarding to an employee at the retail outlet via pager or cellular phone 18 and/or, where appropriate, to a technician via pager 16. If desired, a telephone helpline service desk 20 may be provided in order to assist the retail outlet employee with any task that is required.

In addition, the information may include data 22 relating to routine servicing of the equipment, refrigerator temperature logs and the like. The information may include data or software that may be downloaded in the apparatus for altering its operation after downloading. Such data may include changes to beverage recipes, advertising information, or information that is displayed on any screens on the equipment.

The apparatus for the preparation of coffee and other beverages, is shown schematically in FIG. 2, and the mechanical arrangement is shown in FIG. 3. The apparatus comprises a chassis and enclosure in which a number of modules 21 to 26 are provided for preparing coffee beverages, milk containing beverages, iced beverages and chocolate beverages respectively. Each module is associated with a line or other means for the supply of ingredients such as water, milk, coffee etc. and lines 28 to 36 for the supply of prepared beverages to a fill head 38 where the particular beverage is dispensed into a cup 6. The operation of the apparatus is controlled by a master controller 42 for example in the form of a personal computer, that controls a low level electronics module 44 for operating switches, valves etc. of the milk module, brew module etc. The master controller 42 will typically be programmed by means of a high level language such as Windows® or hypertext markup language (HTML) employing application logic, while the electronics module 44 will normally be written in a low level language such as C. The master controller is also connected to a communications module 46 for allowing it to communicate to the computer 14 located in the owner's establishment, for example by means of a land line, the internet, a dedicated wireless communications system or any other appropriate way. Data lines 48, 50, 52 are provided for allowing data transfer from various input devices for example keys or a touch screen 54 for enabling the customer to select the beverage, a card reader for enabling data to be read from the customer's charge card for payment or from a loyalty card, or a receipt printer 58 for printing receipts for each beverage. The master controller 42 may also communicate with an MDB interface that is connected to a change giver 60 that provides the necessary change for the transaction if payment for the beverage is made by cash.

In addition to the means for supply of ingredients to the various modules, and lines for dispensing the beverages to the fill head 38, the milk module 23 and the brew module 30 may be provided with a line 62 for flushing the modules with cleaning solution, and the brew module may be provided with a discharge line 64 for discharging spent coffee grounds into a drain or container. A water supply and regulation device 66 may be provided to deal with the supply of water from a mains water source, and a further supply and regulation device 68 may be provided for the supply of mains electricity with a power rating typically of 13, 16 or 30 amps.

FIG. 3 is a perspective view showing the physical layout of the main components of the equipment. Within the frame, a coffee bean storage and piercing arrangement 200 is located at the uppermost part of the equipment so that coffee beans can be removed from containers 208 located on the carousel and sent to a coffee bean grinder 930 under gravity. The grinder 930 has an inlet hopper that is capable of receiving a quantity of coffee beans equivalent to one container, and is arranged to grind a quantity of coffee that is required for a single beverage. The grinder is a conventional grinder having a pair of grinding discs that are located together, and one of which is rotated. Below the grinder is located a brewer assembly 78 so that ground coffee can be supplied from the grinder to the hopper of the brewer also under gravity by means of a chute 130. After preparation of the coffee by the brewer assembly 78, coffee liquor is sent to the dispensing head 38 for dispensing into a cup 6 by lines (not shown).

Milk that is required for certain beverages such as cappuccino is stored in containers 502 or so-called “bag in boxes” in a refrigerated compartment 500 located at the bottom of the equipment so that it is not necessary to lift the milk containers for replenishing the milk stock. In the embodiment shown, the refrigerated compartment 500 is capable of housing four such containers, and milk from the containers is passed to a pair of fridge funnels 512 and thence to a load cell 700 in the form of a further funnel to enable a metered quantity of milk to be dispensed for each beverage.

At the front of the frame at mid-height, a user interface screen 54 is located in order to enable the customer to select the beverage and make any other selections. Also, at the front of the equipment to one side of the dispensing head, is located a “faff bin” comprising a number of recesses 160 for storing consumables such as sugar, spoons and the like, and a bin 162 for disposing of used consumables. In addition, the coin change mechanism 60, the receipt printer 58, and the cup and lid stores 932 are also located at the front of the equipment. At the rear of the frame are located enclosures for the master controller 42 and for the low level electronics 44, the water boiler 400 and other equipment. The cup store may be in the form of a metal box that is provided at its front end (facing the user) with an annular flexible seal, preferably resilient, for example formed from an elastomer, which will allow the store to receive a stack of nested cups so that the interior of the end cup is oriented toward the interior of the metal box, and will prevent ingress of dust into the cups. Cups may be removed individually, requiring the annular seal to flex, and the seal will then seal the remaining cups.

The equipment also houses other components such as a water boiler 400, a steam boiler 600, containers 402 for storing cleaning fluids, and a drain 404 for allowing rinsing of liquids during cleaning. A chocolate container 874 containing liquid chocolate may be located in the equipment, preferably in an upper part thereof, to enable chocolate to be passed to the dispensing head via a line 872 under the action of a peristaltic pump 878. The chocolate container may be mounted on a sprung base to enable an empty container to be detected.

The Brew Module

The brew module 21 comprises the coffee brewer assembly 78, the coffee container storage and piercing arrangement 200, one or more coffee grinders, the water boiler 400 and pump.

The Brewer Arrangement

The brewer arrangement is shown in greater detail in FIGS. 4 and 5. The arrangement comprises a generally cylindrical hollow body 80 that is arranged so that its axis is vertical, and forms a chamber 81 for brewing both espresso and filter coffee. The chamber is defined by the hollow body and a pair of pistons 82 and 84 that are slidable within the body 80 along the vertical axis thereof. The body has an aperture at its top end that is sufficiently large to allow the top piston to slide through it out of the chamber, but, at its lower end, has an aperture that is too small to allow removal of the lower piston, so that downward movement of the lower piston is terminated as the piston hits the lowermost part of the body. Each piston 82 and 84 is supported on a shaft 86 and 88 respectively, each of which is itself supported on one of a pair of horizontally disposed mounting bars 90 and 92. The mounting bars 90 and 92 are joined together at each end by means of a pair of parallel, elongate screw-threaded bars or lead screws 94 and 96 that, together with the mounting bars 90 and 92, form a generally rectangular assembly 100. Each lead screw 94, 96 extends through a hole in a base 98 of the brew module so that it can move vertically through the base, and thereby cause the rectangular assembly 100 to move up or down.

Each leadscrew 94, 96 engages a bearing 102, 104 located in a bearing housing 106, 108 as it passes through the base 98. The bearings each have a female screw thread, formed in this instance by a nut, so that rotation of the bearings will cause the leadscrews to move axially through the base 98 in a vertical direction. The bearings 102, 104 are driven by means of a d.c. electric motor 110 and a drive belt 112 that causes each nut to rotate in the same sense so that the rectangular assembly as a whole will move up or down depending on the polarity of the electrical supply to the motor.

The mounting bar 92 at the top end of the leadscrews 94 and 96 is rigidly attached to the leadscrews so that the mounting bar and the top piston will follow the motion of the leadscrews. However, the lower mounting bar 90 is axially slidable along the leadscrews, and is downwardly biased by means of a pair of gas struts 114 and 116 mounted on the base and connected to the lower mounting bar. Each leadscrew 94 and 96 is provided with a head 118 and 120 at its lower end that can engage the mounting bar 90 so that, as the leadscrews move upwards from a lower position, the lower mounting bar 90 and lower piston 82 will remain in a fixed position with respect to the body 80 until the heads 118 and 120 of the leadscrews engage the lower mounting bar 90, and the lower piston 82 will then be caused to move upwardly.

The base 98 has a lower extension 122 that has three position sensors (not shown), for example Hall sensors, for detecting the position of one of the heads 118, 120 at the bottom of the leadscrews.

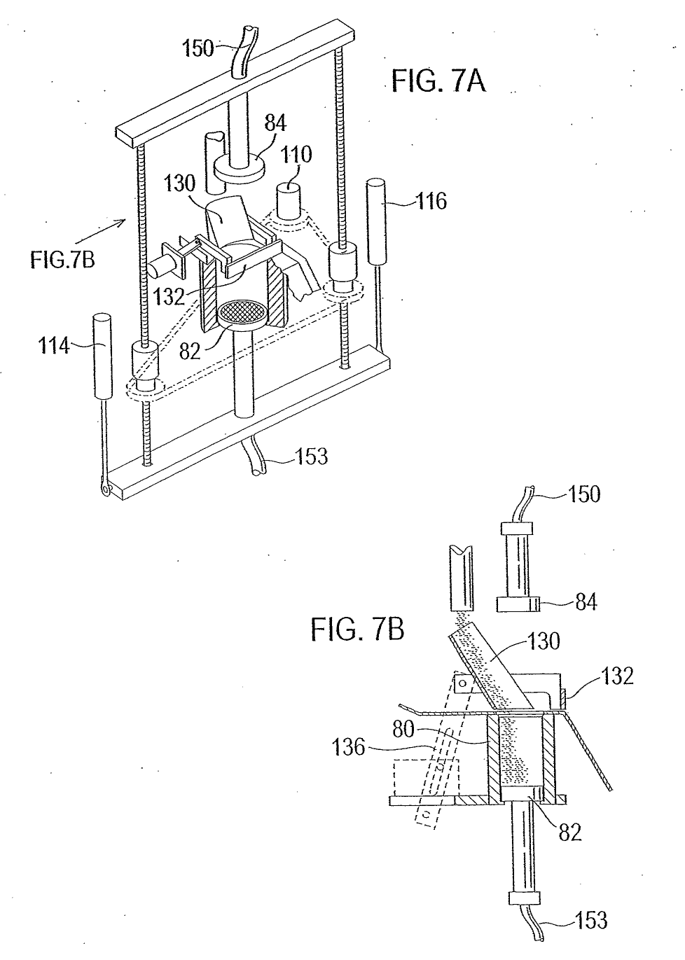

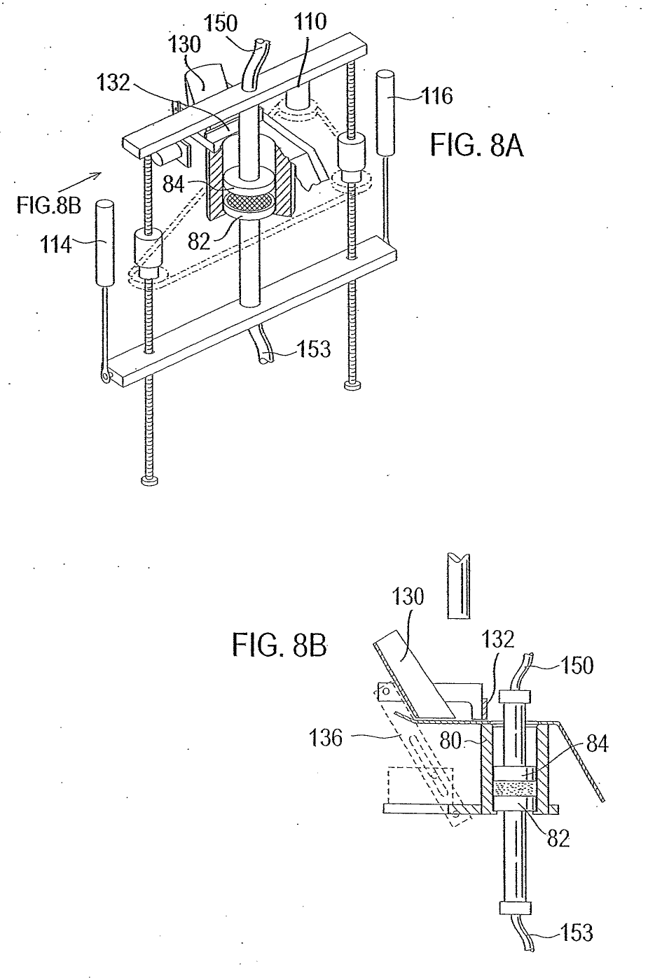

A combined ground coffee chute 130 and coffee puck sweeper 132 arrangement is also mounted on the assembly, and is able to move laterally between a retracted position, as shown in FIGS. 6A and B and FIGS. 8A and B in which the aperture in the top of the body 80 is exposed in order to allow movement of the top piston 84 into and out of the body, and an extended position as shown in FIGS. 7A and B in which the lower part of the coffee chute 130 is positioned over the aperture to allow introduction of ground coffee into the chamber. The coffee chute and puck sweeper arrangement is moved by means of a d.c. electric motor (not shown) and an inverted slider crank mechanism (or Whitworth quick return mechanism) 136. A pair of microswitches are provided in order to establish the position of the motor and coffee chute and puck sweeper arrangement in its cycle, and to cause it to stop in the correct position.

As shown in FIG. 4, the chamber of the brew module comprises a cylindrical aluminium body having a flange 152 at its top end, and is surrounded by stainless steel casing 154. The brew module has a stainless steel liner inside the aluminium body that forms the interior surfaces of the chamber, and a resistance heater in the form of an annular band is provided around the aluminium body in order maintain the brew module body at the correct temperature and prevent water being chilled as it is injected into the body. A thermistor (not shown) may be provided to provide brew chamber temperature feedback.

The top piston 84 is provided with a water inlet tube 150 that extends through the shaft 88, and a coarse gauze 151 on its lower face, while the lower piston has a fine gauze on its upper face, and a tube 153 for allowing the brewed coffee liquor to be extracted and dispensed. Alternatively, a coarse filter may be located in the lower piston 82 and a fine filter be located in the upper piston 84, and the flow of water be arranged so that it flows upwardly from the tube 153 and lower piston 82 to the upper piston 84 to be dispensed via the tube 150.

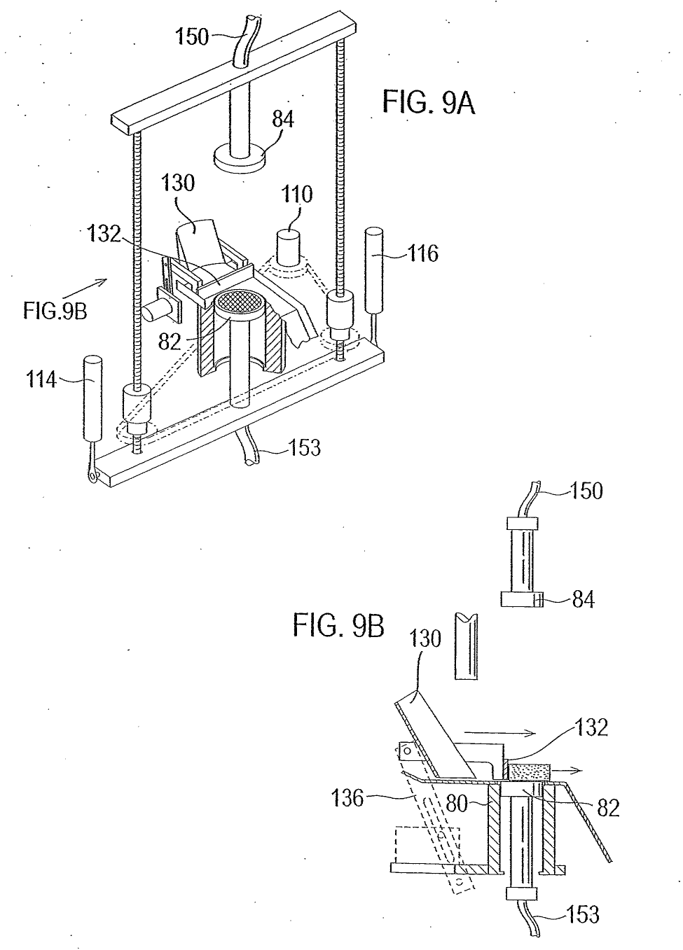

In the parked position, the top piston will normally be located within the brew chamber in order to ensure that the temperature of the brewer is appropriate for production of the beverage. In order to prepare an espresso beverage, the leadscrews are raised to their uppermost position as shown in FIGS. 5, 9A and 9B with head 118 of leadscrew 94 adjacent to the upper position sensor, and the coffee chute 130 is positioned over the aperture in the top of the brewer body. The motor 110 is energised in order to drive the leadscrews 94 and 96 downwards, causing the top piston 84 to move downwardly by virtue of its rigid connection to the leadscrews, and allowing the lower piston to move downwardly under the bias of the gas struts 114 and 116, until position sensor identifies the lower piston as being in the coffee load position. In this position as shown in FIGS. 7A and B, the lower piston 82 may, depending on the design, be at its lowermost position in the chamber, and the top piston is still positioned above the top of the body by a few centimetres. At this point, the coffee bean grinder, described below, is actuated in order to grind the coffee and dispense a charge of ground coffee, typically about 11 g, into the brewer chamber via the chute 130 as shown in FIG. 7B. The coffee chute and puck sweeper mechanism is then caused to move laterally to its fully retracted position, and motor 110 is energised to cause the top piston 84 to move downwards into the chamber until the lowermost position sensor identifies the head 118 or 120 of the leadscrew, and the arrangement is as shown in FIGS. 8A and B, at which point the volume of the space between the pistons has been reduced so that the coffee grounds are compacted. If desired, the upper piston may be arranged to tamp the coffee grounds. Alternatively, the motor 110 may continue to be energised until the top piston 84 is prevented from moving further by the coffee grounds in the chamber.

A small quantity of hot water, for example about 5 ml is forced into the chamber between the pistons in order to pre-wet the coffee grounds, preferably followed by a delay, typically from 1 to 5 seconds, and then by a larger quantity, for example from 30 to 100 ml under a pressure of from 5 to 15 bar, preferably at nine bar, to infuse the coffee grounds. The water will normally take at least 10 seconds, and typically from 12 to 25 seconds to pass through the coffee grounds from one of the pistons 82 or 84 to the other, although in some instances it may take longer, for example up to 1 minute, depending on the grind of the beans and the recipe. The coffee liquor so formed is then sent via line 30 to the fill head 38 to be dispensed.

After dispensing of the coffee liquor, the polarity of the energising supply to the motor 110 is reversed so that the motor will run in the opposite direction, causing the leadscrews 94 and 96, and the piston 84 to rise. As the piston 84 rises, it will exit the chamber through the aperture in the top of the hollow body. At the same time, heads 118 and 120 at the bottom of the leadscrews will engage the lower mounting bar 90 and cause it to rise against the bias of the gas struts 114 and 116. As the lower mounting bar 90 rises, the lower piston 82 also rises until the uppermost position sensor 124 detects the proximity of the head 118 of leadscrew 94. At this point of the cycle, the upper surface 140 of the lower piston will be generally flush with the top surface defining the hollow body, and the spent coffee grounds in the form of a puck will stand proud of the surface. At this instant, motor 134 is energised and rotates by approximately 180° until one of the microswitches 137, 138 causes it to stop rotating, causing the puck sweeper 132 to knock the puck away into a receptacle as shown in FIGS. 9A and B, and causing the coffee chute 130 to be parked above the aperture in the hollow chamber. Normally the brewer assembly will then continue its cycle so that the chute and puck sweeper mechanism retracts and the upper piston is parked within the brew chamber in order to keep it hot. The brew module is thus ready to begin another cycle. It is entirely possible, although not preferred, for the brewer assembly to remain at a different position in its cycle after it has finished brewing and dispensing coffee, for example at a position where the lower piston 90 is located between its top and bottom positions so that the hollow body is able to receive a further quantity of ground coffee.

One of the pistons, normally the piston that is provided with the tube from which the coffee liquor is dispensed, may be provided with a second tube 160, preferably leading directly to a drain. In such an arrangement, the system may be provided with a valve, for example a solenoid valve to allow communication between the tube 160 and the brew chamber, and isolation of the tube from the brew chamber. A pump (not shown) may also be provided, in this case a diaphragm pump, in order to cause any remaining liquid in the brew chamber to be evacuated therefrom. During the brewing process (whether for the preparation of espresso coffee or filter coffee as described below), the valve is closed. At the end of the brew cycle, after the beverage has been dispensed but before the puck of spent coffee has been ejected, the valve may be opened and the pump actuated in order to suck water from the brew chamber before removal of the puck. This operation will normally take only a brief period of time, for example a few seconds. This operation has the advantage that any remaining coffee liquor will be pumped away to drain rather than being reabsorbed into the puck due to the pressure reduction in the brew chamber as the pistons separate. If this coffee liquor is not removed from the spent coffee grounds, the puck can be wet and sloppy, and leave a trail of wet coffee as it moves down the chute. In addition, pumping of the coffee liquor from the brew chamber will cause a back-flow of liquor along the coffee line 30 to clear the line of liquid and so ensure that no coffee drips from the dispensing nozzle after the beverage has been dispensed.

The brewer assembly is also capable of brewing filter coffee, that is to say coffee that is brewed at approximately atmospheric pressure and employing a larger quantity of water than espresso. If, instead of an espresso coffee, the customer selects a filter coffee beverage, the motor 110 is energised to cause the lower piston 82 to be lowered to its lowermost position in the chamber as described above. In this operation, the master controller 42 and low level electronics module 44 operate to cause a somewhat larger quantity of coffee, for example in the region of 10 to 30 g, to be ground and dispensed into the chamber by means of the chute 130. The coffee chute and puck sweeper arrangement are then caused to retract, and motor 110 is then energised to lower top piston 84 as far as the top of the brew chamber 81. The top piston may seal the brew chamber 81 appropriate, for example if water is pumped from the lower piston to the top piston, so that when water is pumped into the brew chamber air in the brew chamber can be displaced via the tube 150 and the line 30. If the water is pumped from the top piston 84 to the lower piston 82, the top piston should not initially enter the brew chamber but should stop at a position such that a small gap is left between the piston and the top of the cylindrical body to allow air to be displaced from the top of the brew chamber. A quantity, for example 50 to 100 ml of hot water, depending on the chamber volume, is then injected into the chamber via the water line and one of the pistons, and air in the chamber that is displaced by the water is allowed to leave the chamber. After allowing the coffee to brew for a period of time depending on taste and the coffee, for example from 10 to 30 s or from 30 to 60 s, the top piston is lowered a few millimetres if necessary to form a seal with the internal surface thereof. A further quantity of hot water is then injected into the chamber via the water line and upper or lower piston, causing the brewed coffee liquor in the chamber to be displaced and dispensed through the coffee line 30 and fill head 38. This may be achieved by means of the mains water pressure (about 3 bar) or, preferably, by means of the high pressure pump that is used for espresso coffee beverages in order to increase the rate of flow of coffee liquor. If the high pressure pump is employed, it is preferred for it to be actuated after a short delay, for example from 5 to 10 s after the second quantity of water is injected into the chamber, in order that coffee is first dispensed into the empty cup at low pressure to prevent foaming. The precise quantity of water that is injected into the chamber may be varied as desired, but will typically be about 150 to 250 ml. After a few seconds, motor 110 is energised to lower the top piston to its lowermost position (or lowest position allowed by the quantity of coffee grounds in the chamber) causing the coffee liquor remaining in the brew chamber to be dispensed and the coffee grounds in the chamber to be compressed into a puck.

After dispensing the coffee liquor, the upper and lower pistons are raised to their top positions, and the puck of spent coffee grounds is removed by the puck sweeper 132 as described above.

In an alternative arrangement of brew chamber, if filter coffee is selected, the pistons may be arranged to move together after the ground coffee is metered into the cylinder to an extent that the volume enclosed in the cylinder by the pistons is approximately 10% greater than the volume of coffee, and water may be injected into the chamber preferably from the lower piston 82. The coffee liquor is preferably removed according to this arrangement via the upper piston while the coffee is allowed to brew, and the arrangement is adjusted so that the brew time is approximately 30 to 60 seconds. After the coffee has brewed, the upper piston 84 is lowered in order to compress the coffee grounds, and a puck of the coffee grounds is ejected as described above.

If desired, the puck sweeper 132 may be biased downwardly, toward the brew chamber 81 (FIG. 4) as it moves from its retracted position (shown in FIGS. 6A and 6B) to its extended position (shown in FIGS. 7A and 7B), and not biased or biased upwardly as it returns from its extended to retracted position. Such biasing may assist to prevent or reduce the possibility of any spent coffee grounds falling into the brew chamber when the puck of spent coffee is swept away, and reduce or prevent any spent coffee grounds adhering to the bottom of the puck sweeper 132 from being dragged back into the brew chamber as the puck sweeper returns to its retracted position. This may conveniently be achieved by providing a horizontal leaf spring (not shown) on either side of the brew chamber and a pair of protuberances on the puck sweeper arrangement that bear on the under surface of the leaf spring in order to bias the sweeper downwardly as it moves from its retracted to extended position. If the protuberances are located beyond the end of the leaf spring in the fully extended position of the puck sweeper, they will bear on the upper surfaces of the leaf springs as the puck sweeper returns to its retracted position, thereby lifting it up from the brewer chamber to a slight extent.

As can be seen from FIGS. 4 and 5, the dimensions of the brewer chamber 80 are only a small fraction of the overall dimensions of the brewer assembly since the height of the brewer assembly must accommodate the length of the leadscrews 94 and 96 and the length of their movement which will depend on the length of piston shafts 86 and 88 and the stroke of the pistons. Thus the brewer assembly can have a height in the order of ten times the height of the brewer cylinder. If the height of the brewer cylinder were simply increased in order to accommodate the volume of a cup of filter coffee, the overall dimensions of the brewer assembly would soon become too great for the equipment housing.

Although it is desirable for the brewer assembly to remain in its parked position in which the upper piston 84 is located within the brew chamber when not in use, this can mean that it takes some time for the brewer assembly to move to a position in which it can start to brew the coffee. In one preferred embodiment, the equipment may include a detector for detecting the presence of a person in the vicinity thereof, and be arranged to retract the top piston 84 to a position above the brew chamber and to move the chute 130 to its position above the brew chamber as shown in FIG. 7B at which the brewer is ready to receive the ground coffee if the presence of a person is detected. Such an arrangement is able to reduce the time taken between selection and dispensing of a beverage by six to seven seconds. The assembly may move back to its parked position if the person is no longer detected, if a beverage not requiring the brewer is selected, of after a predetermined time. If desired, it is possible for the assembly to be arranged so that it does not move back to its parked position but remains in its position where it is ready to receive ground coffee if the detector detects the continuing presence of a person, so that the time taken to dispense successive beverages is reduced, for example by about 10 seconds.

Coffee Container Piercing Arrangement

Coffee is preferably supplied in containers in the form of cylindrical drums containing from 500 g to 2 kg of coffee beans, and especially about 1 kg of beans, so that the entire contents of a container will be consumed before the coffee beans have become stale. The containers may, for example, be symmetrical along their length, e.g. when cylindrical, or they may be asymmetrical along their length so that they can be placed in the apparatus only in the correct orientation. The containers are typically formed from an aluminium foil lined cardboard tube that is closed at each end by a metal foil sheet. The foil has a one-way valve arrangement to allow carbon dioxide given off by the freshly brewed beans to be drawn off.

The containers are loaded onto a piercing arrangement as shown in FIGS. 10 and 11, which show the arrangement with a single coffee container therein. The arrangement comprises a frame 200 supporting a carousel 202 that has a number of recesses 204 for receiving one of the containers, each recess having an aperture 206 to allow beans to drop into a hopper of the bean grinder once the container is pierced. The carousel is designed to receive four bean containers 208, but other numbers of containers may be received. The carousel is provided with a post 210 having at its top end a cruciform device 212 for retaining the containers 208 in place. The cruciform device has four resiliently deformable arms 214 that can be bent upwards slightly to allow a coffee container 208 to be located in the recess 204 of the carousel.

Below the carousel 202, a generally cylindrical foil cutter 220 is arranged within a guide box so that it is able to slide in a vertical direction between a retracted position in which it is entirely below the carousel 202, and an extended position in which it enters the bean container 208 in order to allow discharge of the beans. The foil cutter 220 is moved between its two positions by means of a motor 224 that drives a gear 226. The gear 226 has a groove 228 forming a cam that is engaged by a cam follower pin attached to the lower end of the foil cutter. The foil cutter may be configured so that it has a single apex 232 in its cutting edge for piercing the foil of the bean container, or it may have more than one apex along its periphery in order to enable the slope of the cutting edge to be increased.

The carousel 202 is driven by an electric motor that drives a gear fixed to the under surface of the carousel and is provided with a position sensor, for example a Hall sensor, in order to determine whether or not it is in the correct position to allow contents of a container 208 to be dispensed.

The frame 200 of the arrangement has a rigid bar 216 that extends over two of the positions in which the coffee bean containers are located, one of such positions corresponding to the position of the foil cutter 220. The purpose of the rigid bar 216 is to provide a reaction force to resist upward movement of the coffee bean container 108 under the thrust of the foil cutter 220. Because the arms 214 of the cruciform device are flexible in order to allow the containers to be positioned in the recesses 204 on the carousel, they will not themselves provide sufficient force to resist movement of the container when it is pierced.

In operation, the bean containers 208 are manually loaded onto the carousel so that their metal foil, which seals the container, is oriented downwards and is located in the recess 204 in the carousel. When the master controller 22 receives a signal that the hopper of the bean grinder is empty, motor 224 is energised to cause the foil cutter to move upwards and pierce the foil, thereby allowing the contents of the container to fall through the foil cutter 220 located in one of the apertures 206 into the hopper of the bean grinder. The foil cutter then retracts to its parked position below the carousel, and the carousel is then caused to rotate by 90° and move one of the full bean containers into position over the foil cutter. The drive mechanism for the foil cutter contains a position sensor (not shown) to ensure that the foil cutter is retracted before movement of the carousel. In addition, the carousel is provided with a position sensor, for example in the form of a Hall sensor and magnets, to determine that it has been rotated to the correct position to ensure that a coffee container is located above the foil cutter. A further position sensor may detect rotation of the carousel through 360° in order to indicate that the equipment needs to be supplied with fresh coffee containers. A message may be sent to call a technician if a container fails to open.

The carousel 202 is located over a flat panel 201 in the frame 200 of the piercing arrangement with insufficient clearance to permit a coffee bean to fit between them, with the result that, as the carousel rotates, any coffee beans that did not fall through the foil cutter will be swept along in the aperture 206 by rotation of the carousel. At one position of rotation of the carousel, an aperture is formed in the flat panel, under which is located a tray 230 in which any beans will be collected.

By means of the coffee container piercing arrangement, the equipment may be provided with coffee beans in a number of sealed containers which can be automatically opened, thereby allowing the time period between manual operations to be increased without detriment to the coffee. If desired, it is possible for the time when the grinder hopper is filled to be logged by the software, and for a service alert to be raised if the hopper is not filled again within a predetermined length of time.

Although the arrangement has been described with only a single foil cutter, it is possible for more than one foil cutters to be employed at different positions under the carousel so that different types of coffee may be loaded onto the carousel at the same time.

Water Boiler

The water boiler 400 comprises a generally cylindrical tank having a mounting bar for attachment to the frame of the apparatus. The boiler has a bank of three 800 W heating elements that are independent of one another, a water inlet that takes water from a supply provided with a check valve, an electrical isolation valve and a water treatment device. The boiler has three outlets: a main outlet for supplying hot water to the brewer arrangement, a second hot water outlet for supplying further hot water as required for example in the preparation of Americano coffee, and an outlet for providing water to the steam tank. Alternatively, it is possible for cold water to be introduced into the steam tank. In addition, the boiler is provided with a high pressure relief valve set at approximately 1 MPa to allow for pressure relief for the purpose of safety, a thermal cut-out switch and a temperature control feedback probe to control the heating elements. The boiler also includes a water level sensor for ensuring a minimum level of water in the boiler.

The boiler will normally be filled substantially to its capacity so that there will be no air gap above the water. A rotary vane pump is provided to raise the pressure of water to the required value, for example from 500 kPa to 2 MPa, and especially in the region of 900 kPa (9 bar), and a flow meter is provided to measure the quantity of water that is consumed downstream of the boiler, for example a quantity of 45 ml for a single espresso. The flow meter is located adjacent to the water inlet in order that it does not act as a heat sink, cooling water that is supplied to the brewer arrangement, and any water hoses for supplying water from the boiler to the brewer arrangement will normally be relatively small, having a diameter of not more than 5 mm, and preferably not more than 2 mm in order not to cool the water between the boiler and the brewer arrangement, and because any water sitting in the pipe between different beverage preparations will become cold.

An expansion valve is provided in the water inlet line that is set to a level slightly above the pressure to which the rotary pump will raise the water. The purpose of the expansion valve is to allow water in the boiler that has expanded due to the rise in temperature to expand and drain.

The boiler has a maximum power rating of 2.4 kW by virtue of the three 800 W elements. The number of elements that are employed at a given time will depend on the power budget of the equipment which will depend on the maximum mains power, 13A, 16A or 30A, and the available power at that time which will depend on the number and power consumption of other components that are in operation. For example for circuits of lower power rating, when the equipment is initially switched on, the three elements may be used to heat the water from cold, but when the equipment is in use, priority may be given to other devices such as pumps or the bean grinder.

Milk Module

The milk module comprises a refrigerated storage compartment 500 as shown in FIGS. 12 and 13 in which a number of milk containers 502 in the form of so-called “bag-in-boxes” are held, and a dosing mechanism for supplying predetermined quantities of milk to a mixing chamber where the milk may be mixed with steam in order to heat it in the preparation of white filter coffee or latte, or optionally mixed with both steam and air in order to produce foamed milk for the preparation of cappuccino, or alternatively remain unmixed before being delivered to the fill head 38, for example for dispensing cold milk for example for a white filter coffee.

Refrigerated Compartment

The milk is supplied in standard bag-in-boxes 502 of approximately 13.6 litres capacity which comprise a plastics bag filled with milk inside a rectangular cardboard box, and having a length of flexible plastics tubing 504 extending from one side thereof, sealed at the end remote from the cardboard. The storage compartment 500 is generally rectangular, and can hold a number of containers 502, in this case four containers, but more or fewer containers may be held in the compartment depending on the rate of consumption of the milk. One face of the compartment is in the form of a removable panel 506 that has a shelf 508 for supporting the milk containers within the compartment in use. The panel may be designed so that it can be supported on a wheeled trolley when detached from the remainder of the compartment 500, so that the milk containers may all be handled together and moved to and from the coffee equipment without the necessity to lift the containers. Four electrically operated pinch valves 510 are provided below the shelf 508 of the panel, each of which squeezes one of the lengths of plastics tubing 504 to prevent flow of milk from the container, and can be electrically actuated to release its grip on the plastic tubing to allow milk to flow. In the floor of the compartment 500, two funnels 512, referred to herein as “fridge funnels” are provided which are located directly below the lengths of plastics tubing when the panel is located on the compartment so that milk may be caused to flow from the containers into the fridge funnels under gravity. The containers 502 are arranged within the compartment so that a pair of lengths of tubing 504 from two of the containers will discharge milk into each of the two fridge funnels 512 when the pinch valves 510 are actuated. Each of the pinch valves 510 can be actuated to prevent flow of milk permanently when its associated milk container is empty, or the milk has passed its use-by date, or has been out of the refrigerator for more than a predetermined length of time, and/or a service alert may be actuated.

Each fridge funnel 512 has an inlet to allow cleaning fluid to be introduced therein automatically as explained below, so that parts of the line downstream of the funnels can be cleaned on a regular basis without the need for any personnel to spend time on the operation. In this way, the milk line that extends outside the refrigerated compartment can be cleaned automatically, while the plastic tubing associated with each milk container that forms a path for the milk within the refrigerated compartment will be replaced whenever new milk containers are loaded, and so will not need to be cleaned.

In order to replace the milk in the compartment, the panel is attached to a trolley and removed by wheeling the trolley away from the compartment, and the panel is then replaced after having loaded it with four new containers, inserted the lengths of tubing into the pinch valves, and cut off the sealed end of the tubing.

Whether or not the refrigerated compartment of the apparatus is designed to be operated with a trolley as described above, the use of multiple milk containers has the advantage that one or more containers may be removed and replaced at any convenient time, for example to replace empty containers or containers in which the milk has exceeded its use-by date, even though the compartment may still contain useable milk. According to this arrangement, the equipment may include an arrangement comprising memory and a controller that stores data relating to the use-by date of milk in any container and will prevent milk being dispensed once the use-by date has been exceeded. Any milk that has passed its use-by date may be left in the container or be dumped to the drain. The arrangement may also indicate which containers are empty in order to assist replacement thereof. When an operative replenishes the milk in the refrigerated compartment, he simply reads which containers need to be replaced, replaces them and inputs the use-by date of the new containers into the equipment, for example by means of keys or a touch-screen that is employed for beverage selection. The equipment preferably prevents new milk from being dispensed unless a use-by date has been input. The equipment may also indicate a limited range of use-by dates for the milk, for example up to seven days, in order to simplify data input. Once the data has been input and the refrigerated compartment closed, the apparatus may automatically select from which container milk is taken first, preferably the container with the shortest period before the use-by date. The operative thus need not perform any mental act other than to input the use-by date on the milk container into the equipment. It is even possible for this to be performed automatically if desired, for example by means of a radio frequency identification (RFID) tag or a barcode and scanner.

It is not necessary for the compartment to house four milk containers; more or fewer containers may be employed depending on the anticipated consumption of milk from the equipment. Also, it is not necessary for a pair of milk containers to drain into each fridge funnel 510. In alternative arrangements, a single container tube could be employed with each funnel, or provided that the available space and geometry permit, more than two containers could be associated with one funnel.

Steam Boiler

The steam boiler 600 is generally of the same construction as the water boiler for the brew module, and comprises a generally cylindrical tank having a mounting bar for attachment to the frame of the apparatus. The steam boiler also has a bank of heating elements which, as with the steam boiler, are independent of one another, a water inlet that takes hot water from the water boiler, and a pressure relief valve, and a thermal cut-out. However, the steam boiler has only a single steam outlet for supplying steam to the mixing chamber described below. The steam boiler is provided with two water level sensors positioned one above the other about half way up the boiler, to ensure that the boiler is always about half full of water. The lower level sensor 610 will cut the power to the boiler if the water level falls below that level in order to prevent the elements being exposed if the water level falls, and the upper level sensor will prevent further introduction of water if the water level rises above that level.

Load Cell Assembly

The load cell assembly meters predetermined quantities of milk supplied from the containers in the refrigerated compartment to the mixing module for mixing with steam or air and steam, for each cup of beverage. The assembly comprises a funnel assembly 700 shown schematically in FIG. 14 which is formed from a funnel 702 having a generally annular gutter 704 at its upper region, and a bracket 706 or other mounting device for attachment to a device (not shown) for weighing the funnel assembly, for example a spring balance, strain gauge or means for measuring strain on the mounting device caused by the weight of the funnel assembly. Milk inlet lines 708 and 710 extend from the fridge funnels 512 to allow milk to drain into the funnel 702 under gravity, and allow the funnel to fill if valve 712 is closed. As the funnel fills with milk, its weight will increase until the weighing device indicates that the correct quantity of milk has been introduced, whereupon the weighing device causes the pinch valves 510 to cut off further supply of milk. After the milk supply has been cut off, valve 712 is opened, allowing milk to drain from the funnel to a mixing unit downstream thereof where the milk is mixed with steam or steam and air as desired by the customer. The quantity of milk that will be metered by the load cell assembly will depend on the type of beverage that is selected, and whether or not air will be mixed with the milk before it is dispensed, but typically the load cell assembly will deliver from 100 to 300 ml of milk. It is possible for the equipment to be arranged so that the funnel 702 of the load cell assembly is filled more than once for each quantity of milk that is dispensed. Also, it is possible for the quantity of milk being passed through the line to be monitored by the equipment by measuring the weight of the milk remaining in the funnel 700, and the point at which the milk flow has ended to be determined. This arrangement enables the system to check for any blockages in the milk line or failure of the milk pump.

The gutter 704 is provided for the purpose of cleaning the funnel assembly, which is necessary on a regular basis since the load cell assembly is not refrigerated. During cleaning, valve 712 is opened, and cleaning solution is introduced into the funnel 702 via the milk lines 708 and 710 until the fluid overflows into the gutter 704, thereby ensuring that the entirety of the funnel 702 has been cleaned. Overflow line 718 takes any excess cleaning solution to receptacle 720 for disposal. Gutter drainage line 722 has a valve 724 therein, and is connected to the milk line downstream of the valve 712 to enable the gutter to be drained. After the load cell assembly has been cleaned and rinsed, valve 724 is closed in order to ensure that no residual cleaning solution will contaminate the milk line.

A splash plate 726 is provided in order to limit the quantity of milk that splashes into the gutter 704 during dispensing, and also to protect the milk against foreign particles falling in. In addition, the rim of the funnel 702 extends above the lower part of the gutter 704 by a few millimetres in order to provide a clear demarcation between the surfaces of the funnel 702 which will always be maintained hygienically and the gutter 704 which will necessarily include surfaces that cannot be guaranteed to be clean, for example those parts of the gutter situated above the overflow line 718.

Fluid Lines

FIG. 15 is a schematic layout of the fluid lines of the equipment. Cold water line 801 takes water from the water supply 66 to the water boiler 400 and to the cold water dispensing nozzle 802 via manual isolation valve 804, double check valve 806, automatic isolation valve 808, water treatment cartridge 810, rotary vane pump 812 and flow meter 814. If cold water is to be dispensed, it is sent directly to the dispensing nozzle 802 from the flow meter 814 via a further valve 816. Water that is sent to the water boiler 400 may, after being heated, be sent from outlet 410 along line 820 to the hot water dispensing nozzle 818 of the fill head 38 via valve 822 if an Americano coffee is selected, or it may be sent from outlet 408 to the brewer assembly 824 along line 826, via a further valve 828. After operation of the brewer assembly as described above, brewed coffee liquor is sent along line 30 to be dispensed at brew nozzle 830. In addition, hot water provided from outlet 412 of the water boiler is sent to the steam tank 600 along line 832 via steam fill valve 834. A further line 836 is provided to allow manual draining of the water boiler 400.

Steam generated in the steam boiler 600 is sent, when required, along steam line 838 to a mixing unit 840 where it can be mixed with air from air line 859 after the air has been filtered by means of filter 860. The steam is normally supplied at a constant flow rate during operation of the equipment, but which can be varied by a technician for example during commissioning or maintenance. Compressor 864 provides a fixed flow rate of air under a positive pressure for mixing with the steam which may be sent via a reducer and which can be controlled automatically by software control depending on the selection of beverage. The mixing unit is shown in greater detail in FIG. 16, and comprises a steam restrictor 842, steam/air “T” piece 844 for allowing steam to mix with air, steam non-return valve 846, air non-return valve 848 and a milk “T” piece 850 where the steam and optionally air are mixed with milk supplied from milk line 852 that pumps milk received from the load cell arrangement 700 by means of a gear pump 866. The end of the milk line 852 extends into the bore of the steam and air line 854 at the point at which the fluids are mixed in order to create the necessary turbulence in the fluid mixture for foaming the milk. After the milk has been mixed with steam, it sent along line 868 to the milk nozzle 870 in the fill head. Depending on the selection made by the customer, the mixing unit can supply hot milk by mixing the milk with steam, foamed hot milk by mixing the milk with steam and air or simply supply cold milk. It is also possible to vary the temperature of the milk by adjusting the flow rate of the milk and steam. Ideally, a temperature of from 50 to 80°, especially from 60 to 70° C. is obtained depending on the type of drink desired. Typically, the foamed milk will have a proportion of 30 to 50% air and a temperature of 55 to 65° C., while steamed milk will typically have a proportion of air at 10 to 30% and a temperature of 65 to 75° C. Thus, although the absolute flow rate of steam is fixed, it is possible to vary the relative flow rate of all three components by varying the flow rate of air and milk with respect to that of the steam. The flow rates may be varied by adjusting the steam boiler pressure, the speed of the milk pump and the speed of the air pump and/or altering any restrictor (both affecting the flow rate). The system has the advantage that all the fluids (air, milk and steam) are introduced at a positive pressure, i.e. greater than atmospheric pressure. Accordingly, unlike foam generating systems in which one component is entrained by means of a venturi or otherwise sucked in, it is possible to adjust the proportion of the components in order to optimise the foamed milk, rather than the proportions being set by the geometry of the system and physics. In addition, it is possible to alter the quantity of air in the foamed milk by varying the length of time during which the air valve is open. For example, if the air valve is open during the entire milk dispensing period, it is possible to obtain a mixture of approximately equal parts foamed milk and unfoamed hot milk, while, if the air valve is open for half the milk dispensing period, a mixture of approximately 75% unfoamed hot milk and 25% foamed milk may be obtained.

The equipment is further provided with a chocolate line 872 that supplies liquid chocolate from a bag-in-box container 874 to the chocolate dispensing nozzle 876 by means of a peristaltic pump 878. The equipment is thus able to supply on demand hot or cold water, hot or cold milk, foamed milk, espresso or filter coffee, or combinations thereof such as latte, cappuccino, Americano and the like.

In addition to dispensing the various beverages, it is desirable that the relevant fluid lines are automatically cleaned on a regular basis, especially those lines that carry milk. In order to achieve this, containers of cleaning chemicals 880 and 882 are provided, usually in the form of concentrates so that they may be stored within the equipment. Normally two different chemicals will be employed, for example one comprising a descaler to descale the lines, and another comprising an alkaline based detergent containing a biocide, fungicide etc. to clean and disinfect the lines. Of course, different chemicals and different numbers of chemicals may be employed depending on circumstances, and for example, different chemicals may be employed for cleaning the milk line and the coffee line. Peristaltic pumps 890 and 892 may be used to engage dip tubes inserted into containers of the cleaning chemicals to retrieve the chemicals from the containers and to pump the chemicals along lines 884 and 886 to a chemical mixing tank 888 where the chemicals, either together or individually, are mixed with water from line 894. The design of the chemical mixing tank is generally the same as that of the funnel assembly 700 for the load cell, although in this case, four inlet pipes will be used, two for the chemicals, one for water from line 894, and one for recycling the cleaning fluid. The cleaning operation is normally initiated by means of a clock so that it is conducted at periods of low use. During the cleaning cycle, a defined quantity of water, for example as measured by a flow meter, is mixed with a defined quantity of cleaning concentrate measured by the mixing tank 888. Alternatively the quantity of cleaning fluid so formed may be determined by measuring the weight of the cleaning fluid in the chemical mixing tank 888. After the cleaning chemicals are weighed and mixed with water, they are pumped by means of pump 896 along one of lines 898 or 900 leading to the fridge funnels 512 or the brewer 824 respectively. Valves 902 and 904 located in lines 900 and 898 respectively are automatically actuated in order to direct the appropriate cleaning fluid to the brewer or to the milk line.

Cleaning fluid that is intended for cleaning the milk line is supplied to the fridge funnels 512 from where it flows along lines 708 and 710 to the funnel assembly 700 of the load cell. The cleaning fluid is allowed to flood the funnel assembly and the gutter 704, preferably up to a higher level than that of the milk during dispensing of a beverage, and especially the level of the overflow line 718 in order to ensure that all surfaces that will be in contact with milk are cleaned and sterilized. During this operation, the quantity of cleaning fluid that has passed through the funnel 700 is accurately determined by means of the load cell, and the value obtained is checked against the quantity of cleaning agent (or cleaning concentrate and water) determined by means of the chemical mixing tank 888 and its associated weight sensor. If there is any significant discrepancy in the quantity of cleaning fluid determined by the mixing tank 888 (or the sum of the weight of water and concentrate) and that determined by the load cell, this is indicative of a leak in one of the lines or a malfunction of either the mixing tank 888 or the load cell, and the equipment is taken out of service. It is possible, if desired, although not preferred, for the apparatus to sound an alarm or prevent dispensing of any further beverages only if the quantity determined by the mixing tank 888 is greater than that determined by the funnel 700, or only if the quantity determined by the funnel 700 is greater than that determined by the mixing tank 888. Because the system is cleaned every day, the load cells of the mixing tank 888 and funnel 700 are checked against each other at the same frequency. The cleaning fluid is then pumped by pump 866 to the mixing unit 840 and then along the milk line 868 to the milk dispensing nozzle 870 in the fill head. The cleaning fluid cannot flow up the steam or air lines because its flow in the mixing unit is prevented by the non-return valve 846. During this cleaning cycle, the entire quantity of cleaning fluid is accounted for by means of the mixing tank and the load cell, in order to ensure that no cleaning agent is subsequently dispensed in a beverage.

It is possible for the cleaning fluid to be flushed through the lines in a single pass and to leave the system at the dispensing nozzles to be collected in a waste receptacle. However, the cleaning fluid may be recycled so that it flushes the lines a number of times. In order to achieve this, the nozzles in the fill head unit 38 may be arranged in a movable nozzle unit 906 shown schematically in FIG. 15 and in greater detail in FIG. 19. FIG. 19 shows the fill head schematically in its normal operating position where a cup 6 is placed on a perforated platform 907. The fill head may be automatically lowered into a container 908 before cleaning. The container may conveniently also provide the function of a spill tray for receiving spillages of beverage when they are dispensed. The nozzle unit 906 has a seal 910 that blocks the outflow pipe 912 of the container when the nozzle unit is lowered into the container 908 during cleaning as shown in FIG. 19c in order to prevent the cleaning fluid being lost, and a second outflow pipe 914 that generates a constant depth of liquid in the container 908 before recirculating the cleaning fluid along line 916 to the chemical mixing tank 888. When cleaning has finished, the container 908 may be raised to a position as shown in FIG. 19b in order to allow cleaning fluid to drain through pipe 912. The operation may be repeated with a different cleaning fluid and with water to rinse the lines. This form of nozzle unit and container has the advantage that the individual nozzles are immersed in the cleaning fluid so that the external surfaces of the nozzles, which may be contaminated with milk residues caused by splashing when the beverages are dispensed, are also cleaned.

If the cleaning fluid is recirculated through the lines, it is possible for it to be recirculated continuously, but the cleaning operation should end with the quantity of cleaning fluid being determined by the mixing tank 888 and the load cell in order to ensure that all the cleaning fluid has been removed from the system at the end of the cleaning cycle.

In order to clean the coffee lines, valves 904 are closed, and valve 902 in the line 900 leading from the chemical mix tank to the brewer arrangement is opened, and the cleaning operation is repeated, employing different cleaning chemicals as required. Various means may be employed to establish that the cleaning fluid has, in fact, cleaned all the relevant lines. For example, a flow meter or positive displacement pump may be used to ensure that the chemical cleaning liquids have been removed from the containers 880 and 882, and a flow meter to ensure that water has been introduced into the tank 888. A load cell may be provided on the chemical mixing tank 888 to confirm that the chemicals have been pumped from the containers into the mixing tank 888. Alternatively or in addition, the load cell arrangement 700 in the milk line may be used to verify or to check that the cleaning liquid has been supplied to the lines. If the brewer assembly includes a valve and pump associated with one of the pistons and a separate line 160 to drain excess coffee liquor after dispensing the coffee as described above, the valve is advantageously opened and the pump activated for a short period during the cleaning process in order to prevent build up of coffee residues in the pump, valve and line. After the final flush with water, the fill head is automatically raised to its normal position, and the equipment is ready for dispensing further beverages.

In addition to cleaning the system using the cleaning fluids, the apparatus can also flush the milk line with clean water after periods of inactivity in order to prevent any milk drying and sticking to the surfaces. The fill head 906 is lowered to the flush position as shown in FIG. 18 and water is introduced into the chemical mixing tank 888 by opening the clean water pinch valve 895. It is pumped to the fridge funnels 512 by the cleaning pump where it drains into the funnel assembly 700 from which the milk pump 866 pumps it to the fill head, container 908 and drain.

In an alternative arrangement, instead of employing a seal on the nozzle unit 906 to block the drainage outlet of the container 908, the container may be provided with an electrically actuated valve block unit at its drainage outlet which allows liquid in the container to drain through one of two outlets, one leading directly to a waste receptacle, and the other connected to line 916 for allowing cleaning fluid to be recirculated to the mixing tank 888. In this arrangement, the path of the outlet connected to line 916 may be caused to rise by a short distance, for example one or two centimetres, in order to ensure the correct depth of cleaning fluid in the container during cleaning. Other arrangements may alternatively be used. For example, the spill tray or container 908 may have two outlets, a lower one to allow normal drainage and a higher one to ensure the correct depth of cleaning fluid in the tray during cleaning of the fill head, the lower outlet being closed by an electrically actuated valve, for example a pinch valve. The depth of cleaning fluid can be set by the height of the upper drainage outlet, and/or by the quantity of cleaning fluid used.

Fill Head

The fill head is shown in greater detail in FIGS. 17 and 18. The assembly has an opening for receiving a beverage cup 6 placed in position by a customer before receiving a drink, the opening being defined by the nozzle unit 906, and a cup placement stand (which also provides the spill tray or container 908 for receiving beverage spills and the cleaning fluid). The nozzle assembly 906 is supported by a hollow shaft 926 that allows the various fluid lines to extend to the nozzles 818, 838 etc. thereof, and is itself supported by means of a post 930. The nozzle unit 906 can be raised and lowered by means of a low voltage electric motor that has a pinion 934 engaged with a rack 936 on the post, and has a power such that it cannot damage a user's finger if one is incorrectly positioned. The arrangement may include a tensator spring which provides a force to compensate for the weight of the fill head. The electric motor may be provided with a shaft encoder in order to ensure that the system always knows the current height of the nozzle unit 906 A microswitch may be provided to indicate when the nozzle unit is at its lowest position, and a further sensor may be provided for indicating when the nozzle unit is at its uppermost position.

The nozzle unit 906 is capable of vertical movement in order to enable it to be lowered into the container 908 for cleaning purposes as described above, and also to enable it to be moved to a position slightly above the top of a cup that has been positioned where it can prevent splashing of beverage from the cup during dispensing. For example, cups of different sizes may be required for different beverages, ranging from small, for an espresso, to large for a large cappuccino or filter coffee. The master controller 42 will know what beverage has been ordered by the customer, and may cause the nozzle unit to be lowered to a position that allows the appropriate size cup to be positioned in the opening. In addition, a plurality of light or infrared emitters and detectors 921 (shown in FIG. 3) positioned in a vertical array in the recess to the side of the cup when it is placed in position will enable the size of the cup inserted in the opening to be determined, and will prevent a beverage being dispensed if the cup is too small, thereby avoiding any spillages caused by the incorrect size of cup. If desired, the software may return to the choice menu on the user interface screen 54 if an incorrect size cup is chosen and/or a warning may be displayed.

In one embodiment, the coffee line 30 (shown in FIGS. 3 and 15) that terminates at the nozzle 818 may increase in diameter, in the region of the nozzle for example by about 2 to 3 times so that the speed of flow of coffee through the line for any given flow rate is reduced at the nozzle, and the propensity of the coffee beverage to form bubbles when dispensed is reduced.

Electronics

FIG. 19 shows the general layout of the electronics components. These comprise a master controller 1000 in the form of a standard personal computer running an operating system such as Windows (trademark) and a low-level controller 1002 that controls the operations of the mechanical devices 1003 such as the brewer assembly, the carousel, switches, valves etc. Mains power supply 1004 is fed to the master controller 1000, to the low level controller 1002 and to any other components that require mains such as the brewer, and water heaters, and also to a 24 volt d.c. power supply unit 1006 for supplying power to the low-level controller 1002. The low-level controller has a processor printed circuit board 1008 that provides 24V d.c. power to the components such as actuators and small motors, and also 5V d.c. for items such as sensors and any processors. The low-level controller also has a power pcb 1010 that can provide mains supply to the components in addition to 24V and 5V supplies. The master controller 1000 and the low-level controller 1002 can communicate with one another by means of an RS232 serial cable 1012. All items are shielded so that it is not necessary to provide interlocks for the various components.

High Level Software

FIG. 20 shows the layout of the master controller 1000. It comprises a CPU 1200, an internal databus 1202 that connects the CPU to memory 1204 and to interfaces including a communications interface 1206, a touch screen 54, a card reader 56, a receipt printer 58, and an interface 1214 to for the RS232 line 1012 that connects the master controller to the low level controller 1002.

The software for running the master controller is based on a master/slave architecture. The master controller 1000 implements all the high level logic, coordinating all the equipment's activities while specific operations such as making and dispensing a beverage are left to the low-level controller 1002. The high level software is partitioned in a three tier design with clear interfaces between the tiers as shown in FIG. 20. The user interface tier 1020 includes all human interaction with the equipment whether the customer, the retail staff or the technician. Most user interface will be through the touch screen 54 connected to the master controller.

The user interface is hosted in a standard proprietary forms application 1221 which will present content, for example Macromedia Flash® content, on the touch screen via an embedded Flash player control hosted inside a standard form running in full screen mode that is configured to run at start up. The content or “Flash movie” is a sequence of interactive multimedia images that may be played on a standard personal computer using a Windows® operating system and a Flash player through the touch screen.

“Flash” enables the creation of visually dynamic and interactive online user experiences while keeping files very small for fast downloads. This enables the equipment to be updated over the internet.

The software may, for example, employ ordinary .NET forms which allow the flash content to be presented inside windows in Microsoft Windows® operating systems. Depending on the mode of the equipment, a different user interface is required. Each operating mode has its own Flash movie and its own customised plug-in forms.

The vending operation in which the equipment is running normally, either serving a customer or waiting for a customer to approach the equipment. The “out of service” mode displays a single screen with a message that there is a problem with the machine. The refill mode is used by the retail staff when stocking the equipment with consumables, and the service mode is used by a trained technician when servicing, diagnosing faults or repairing the equipment. The cleaning mode is entered when an automatic clean cycle is activated, during which the touch screen displays an appropriate message and ignores user input.

The next tier is the operating logic tier 1022 which contains software that encodes the rules to which the equipment adheres, for example, definitions of beverage offerings and recipes, access to retail staff and technician functions, software upgrades, sales data management, loyalty schemes, payment, freshness monitoring of ingredients, and deciding when the equipment will perform automatic cleaning operations.

The operating logic tier has the following specific programs:
(i) Drink dispensing. This determines when the equipment is ready to dispense a beverage, for example when it has been initialised so that sufficient ingredients are available, the water is hot enough, and the equipment is not undergoing a cleaning cycle.
(ii) Automatic cleaning. This will normally be based on a time input, for example gauged for a time of low usage.
(iii) Sending retail alerts for personnel in the retail outlet to conduct any operations such as refilling any ingredient containers.
(iv) Logging sales. Sales that are logged will be sent on a periodic basis to the operator headquarters.
(v) Equipment shut-down in the event of malfunction.

The vending API (vending application programmer's interface) is an interface that defines which calls and data structures should be used to interact with a software library containing the operations of the system. It allows the low level software and the high level software to be developed and tested independently of the other.

FIG. 21 is a state transition diagram of the operation of the main controller. All the specific operations are performed by the low level controller. On start up, the equipment passes to an initialisation step S10, after which the system passes to S20 where it awaits the presence of a customer. On receipt of instructions from the customer it dispenses the appropriate beverage at S30 and then returns to the waiting mode. Periodically the system will move to step S40 whereupon it will perform a self cleaning operation before returning to the waiting mode. This operation may be suppressed if detectors located on the equipment detect the presence of a customer in the vicinity of the equipment in order to enable the equipment to serve the customer. In the event of a fault while serving a customer or upon initialisation, the system will move to step S50 where the system will display an “out of service” message and will call a retail assistant (S60) or a technician (S70).

Below the operating logic tier is the abstraction tier 1024 which presents generic interfaces to the higher tiers in order for changes to be made without modifying the business logic or user interface. This enables the database engine to be changed or other items such as the receipt printer to be changed if they become obsolete. The main areas of the abstraction layer are the data abstraction 1026 that enables the storage engine to be changed in future, the configuration abstraction 1028 that enables the way data are stored to be changed, hardware abstraction 1030 which enables the choice of peripherals to be changed, and communications abstraction 1032 which enables different communications strategies to be adopted.

Remote access to all the equipment in the field is provided by a standard proprietary software package, for example Windows Desktop (trademark), and upgrades can be deployed and executed using the remote access features. Management facilities of the software can be used automatically to maintain the database deployed on each equipment. Jobs may be scheduled to run regularly to ensure records that are no longer required are deleted.

The database schema and main relationships are shown in FIG. 22. Each entity that is referred to by other entities has a unique primary key (PK) field, and may have one or more foreign key (FK) fields that is a reference to a primary key field of another entity.

The log table 1100 is a large, system-wide event log that captures software events ranging from debug information to hardware failures and unexpected software exceptions, and indicates the time of occurrence (TS). The log is replicated at the HQ 14 at regular intervals.

The product table 1102 is a read-only table of product offerings, and each beverage is represented by a record in this table. Variants of a beverage such as “extra espresso shot” etc. are not classed as product entities in their own right but may be included as options.

The sale table 1104 records all beverage sales made, and the sales data are replicated regularly at the HQ. Each record represents the sale of a single beverage.

The option table enumerates all possible options for all of the beverages on offer, and each record represents an option available to the customer.

The product option table 1108 details the choices available for each option, on a per beverage basis. For example, the table may record the detail that espresso may only be served in a small size, whereas filter coffee can only be served in a regular or large size.

The Sale Option table 1110 records, for each sale made, which options were chosen by the customer. This allows data mining to be carried out on sales data.

Low Level Software

As with the high level software, the low-level software has an abstraction layer, the main purpose of which is to abstract away details of the hardware, such as the sensors and actuators so that the hardware can be changed and upgraded with minimal effect on the software. In addition, the low-level software has a control logic layer that provides low level control of hardware such as valves, pumps and motors.

The hardware abstraction layer deals with all accesses to the hardware, i.e. the various peripherals on the microprocessor that are directly connected to sensors or actuators, for example digital I/O controls, A/D converters, PWM controllers for driving actuators such as motors at different speeds, and counters/timers e.g. for shaft encoders.

The control layer is responsible for performing periodic operations such as PID (proportional integral, derivative) control of heating elements, as well as calculation of derived parameters (e.g. position based on encoder count and previous knowledge. These operations use knowledge of the current sensor/actuator values as obtained/set by the hardware abstraction layer to derive values/set outputs for other devices. Other operations include filtering analogue sensor values to reduce electrical noise induced between the sensor and the microprocessor, and ramping up and down of PWM outputs to minimise surges in power within the system. Processes will be set a desired PWM level as a set point, and the actual PWM will be varied under closed-loop control. An additional operation is the derivation of parameters with no direct physical meaning, for example the fact that the brew module is ready, which will be a combination of various devices in the right position or at the correct temperature. Other physical parameters such as speed can be calculated despite not reading them directly. Some of the derived parameters will be used to update actuator values, especially in the case of sanity checking (e.g. an incorrect setting of actuators is detected and corrected).

The sequencing is concerned with performing the sequencing of the various modules in the equipment. This sequencing will be performed by finite state machines (FSMs) which are often, but not necessarily, directly associated with the mechanical modules. The FSMs will control the mechanical and electrical elements of each module under control of the sequencer which is responsible for ensuring events are passed to the appropriate FSM, that the FSMs are processed regularly and commands to and from the high level software are passed to the appropriate module(s).

The flow of the low level software is shown in FIG. 23. The main loop from Wait to Write Actuators is run at 10 ms intervals (called frames). This provides a 100 Hz rate for reading, updating sensors and performing state machine transitions.

The necessary initialisation is performed at step S1, including disabling watchdog timer (to prevent resets until ready), setting up the microprocessor, system clock, etc. setting up the communications channels, setting up peripherals: pins as in input/outputs, correct settings, intialising state machines, and enabling watchdog timers.

The software then waits (step S2) for some communication from the high level software when, depending on the contents of the message, it will: wait for more commands, start running the equipment, or ender the code update process prior to loading new software. This effectively allows the high level software to “ping” the low level, waiting for a response, and on receipt of a response can supply a regular heartbeat signal and set it running whenever desired. Once running, regular messages should be received from the master, and in the event that do not occur, the low level software will wait for a predetermined timeout before setting actuators to a sensible position and entering a wait state.

The main loop works around the step of reading all the sensors and checking them for consistency (steps S4 and S6). Then periodic operations can be run on the sensors before the FSMs are processed. The state machines are then sequenced (Step S8), i.e. all states are evaluated and any transitions executed. This could be as a result of high level commands or sensor values. Updates to output values are written to a copy of the currently active set. Next, if permitted to continue, the actuator settings from the FSM sequencing are checked for consistency (step S10) before being copied to the current actuator set and being written to the actuators themselves (step S12). This process ensures that all input/output is deterministic, while allowing consistency/sanity checks on all incoming/outgoing values.

The idle state (S14) is identical to the initialisation position with heaters etc running but no movement of mechanical items. This ensures that the equipment is in the right state to start processing commands as and when required.

If a code update (S16) is required, the software can call the update procedure. This copies itself into RAM and then starts the update process. This consists of downloading the code update from the master, verifying its integrity, blowing to flash and again verifying its integrity. In the event of corruption of data in flash, or when no code is present after manufacture, the microprocessor's built in bootstrap loader can be used. For normal code updates, no operator intervention in the machine will be necessary. For repairs due to corrupted memory or during manufacture, code can be loaded across the serial port and into flash.

1-71. (canceled)

72. Apparatus for preparing and dispensing beverages which is adapted to operate in an operating mode in which it can receive instructions from a user to prepare and dispense a beverage, and to operate in a cleaning mode in which parts thereof are automatically cleaned and in which it cannot dispense a beverage, wherein the apparatus is operative to switch automatically from the operating mode to the cleaning mode in response to a predetermined event.

73. Apparatus as claimed in claim 72, which is operative to switch from the operating mode to the cleaning mode at a predetermined time.

74. Apparatus for preparing beverages, which includes a device for storing or preparing a liquid component of the beverage and delivering the component to a beverage dispenser along a line, the apparatus including a storage location for storing one or more cleaning agents for cleaning the line, a device for introducing a predetermined quantity of the or each cleaning agent into the line, and for introducing a quantity of water into the line after introduction of the cleaning agent, in order to rinse the line of cleaning agent, the apparatus including a control mechanism to prevent introduction of the cleaning agent into the line when a beverage is being prepared and dispensed, and to prevent preparation and dispensing of a beverage while the line is being cleaned.

75. Apparatus for preparing and dispensing beverages that contain a perishable component from a dispenser, which comprises:
i) a line for the perishable component that is required to be cleaned by means of a cleaning agent;
ii) a perishable component meter for determining the quantity of perishable component that is dispensed in a beverage;
iii) means for introducing a quantity of cleaning agent into the line, passing it through the line and removing it from the line during a cleaning operation; and
iv) a cleaning agent meter for determining the quantity of cleaning agent that is introduced in the line;
wherein the quantity of cleaning agent that is introduced into the line is also determined by the perishable component meter, and the apparatus is operative to prevent dispensing of a beverage and/or to generate an alert in the event of a discrepancy between determinations by the perishable component meter and the cleaning agent meter during the cleaning operation.

76. Apparatus as claimed in claim 75, which includes a pump for introduction of cleaning agent into the cleaning agent meter, a second pump for pumping cleaning agent from the cleaning agent meter to the perishable component line, a valve between the cleaning agent meter and the perishable component line, and a controller for the pumps and the valve that allows cleaning agent to pass to the perishable component line only during a cleaning operation.

77. Apparatus as claimed in claim 74, which is operative to ensure that all cleaning agent is removed from the line before a subsequent beverage dispensing operation.

78. Apparatus as claimed in claim 74, which is operative to determine the quantity of component of the beverage and the quantity of cleaning agent by weight.

79. Apparatus as claimed in claim 75, wherein the perishable component meter and the cleaning agent meter each comprise a receptacle for liquid, and a sensor that is separate from the receptacle.

80. Apparatus as claimed in claim 74, which includes a return path from the dispenser to the line for enabling the cleaning agent to be recirculated.

81. Apparatus as claimed in claim 74, which includes a beverage dispenser and/or a cup support that is movable between a dispensing position in which the apparatus is operative to enable beverages to be dispensed, and a cleaning position in which the relative position of the dispenser and cup support prevents a cup being offered to the apparatus.

82. Apparatus as claimed in claim 81, wherein the beverage dispenser and/or cup support is movable between a dispensing position in which the apparatus is operative to enable beverages to be dispensed, and a cleaning position in which it enables cleaning agent in the line to be recirculated.

83. Apparatus as claimed in claim 74, wherein the beverage dispenser is movable between a dispensing position in which it is operative to enable beverages to be dispensed, and a cleaning position in which external surfaces thereof can be cleaned by the cleaning agent.

84. Apparatus for preparing and dispensing beverages that include milk, which includes a refrigerated chamber for storing at least one milk container, a milk line for allowing milk to be taken from the container and passed to a dispensing arrangement, and means for cleaning the milk circuit along at least a part thereof that is not refrigerated, wherein the milk line comprises a refrigerated line that is located within the refrigerated chamber, and a second line that can be cleaned and which located outside the refrigerated chamber, the refrigerated line and the second line being spaced apart from one to allow cleaning of the milk circuit while allowing milk to remain in the container.

85. Apparatus as claimed in claim 84, wherein a part of the second line that is adjacent to the refrigerated chamber includes an arrangement that allows introduction of cleaning fluid therein.

86. Apparatus as claimed in claim 84, which includes an arrangement for automatically and periodically introducing cleaning fluid into the milk line.

87. Apparatus as claimed in claim 84, wherein the refrigerated line is disposable together with the container.

88. Apparatus for preparing foamed milk beverages, which includes an arrangement for foaming milk by introducing milk, air and steam into a mixing chamber, the apparatus having a device for independently varying the relative flow rate of the milk, air and steam.

89. Apparatus as claimed in claim 88, which is arranged so that the flow rate of steam is constant during any foaming operation, and the flow rate of the milk and air is adjusted with respect to the flow rate of steam.

90. Apparatus as claimed in claim 88, wherein the flow rate of air and milk is controlled by means of pumps.

91. Apparatus as claimed in claim 90, which includes a control device to vary the flow rate of air and milk in accordance with the beverage selected.

92. Apparatus as claimed in claim 88, which is operative to set the flow rate of milk with respect to that of steam so that the temperature of the foamed milk is in the range of from 50 to 80° C.

93. Apparatus as claimed in claim 92, which is operative to set the flow rate of milk with respect to that of steam so that the temperature of the foamed milk is in the range of from 60 to 70° C.

94. Apparatus as claimed in claim 88, which includes an arrangement to cause introduction of each of the air, milk and steam into the chamber at a pressure greater than atmospheric pressure.

95. Apparatus as claimed in claim 88, wherein the mixing chamber is in the form of a “T” piece in which the end of the milk line extends into the bore of the line for steam and air.

96. Apparatus as claimed in claim 88, which includes an air valve, and the quantity of air in the foamed milk is altered by varying the length of time during which the air valve is open.
